(19) United States
(12) Patent Application Publication
(10) Pub. No.: US 2015/0355397 A1
(43) Pub. Date: Dec. 10, 2015

(54) OPTICAL FILM, POLARIZING PLATE, AND LIQUID CRYSTAL DISPLAY DEVICE

(71) Applicant: FUJIFILM Corporation, Tokyo (JP)

(72) Inventor: Yoshinori MAEDA, Kanagawa (JP)

(73) Assignee: FUJIFILM Corporation, Tokyo (JP)

(21) Appl. No.: 14/734,553

(22) Filed: Jun. 9, 2015

(30) Foreign Application Priority Data
Jun. 10, 2014 (JP) 2014-119626
Jun. 3, 2015 (JP) 2015-113160

(51) Int. Cl. G02B 5/30; G02F 1/1335

(52) U.S. Cl. CPC G02B 5/3083; G02F 1/133528

(57) ABSTRACT

The objective of the present invention is to provide an optical film which shows an improved developability of optical characteristics per unit thickness and concurrently shows excellent moisture dependence and optical stability under hygrothermal conditions, and to provide a polarizing plate and a liquid crystal display device using such optical film. The present invention provides an optical film including a cellulose acylate whose degree of substitution of acyl group is from 2.0 to 2.6, satisfying Formula 1 and Formula 2 below, and having a thickness of 40 μm or thinner; Formula 1: ΔRth(RH)/Rth(550)≦0.12 and Formula 2: ΔRth(60° C.90% 1d)/Rth(550)≦0.05, in the formulae, ΔRth(RH)=Rth(30%)−Rth(80%) and ΔRth(60° C.90% 1d)=Rth(60° C.90% 1d)−Rth(initial).

### CROSS-REFERENCE TO RELATED APPLICATIONS

The present application claims priority under 35 U.S.C. §119 to Japanese Patent Application No. 2014-119626 filed Jun. 10, 2014 and Japanese Patent Application No. 2015-113160 filed Jun. 3, 2015. Each of the above applications are hereby expressly incorporated by reference, in its entirety, into the present application.

### TECHNICAL FIELD

This invention relates to an optical film, a polarizing plate, and a liquid crystal display device.

### BACKGROUND ART

Application of liquid crystal display device to TV set has been expanding these years, with growing demands on higher image quality as a result of expanding screen size, and cost down. High quality has also been required for optical film used for the liquid crystal display device, so that a variety of optical films have been proposed.

For example, Patent Literature 1 describes a cellulose acylate film which shows a suppressed environmental moisture-dependent change in retardation as a result of incorporating a highly hygroscopic heterocyclic compound. Patent Literature 2 describes a cellulose acylate film having a good hygrothermal durability of retardation as a result of incorporating a cellulose acylate resin and a partially ring-opened product of styrene-maleic anhydride copolymer.

Patent Literature 3 describes an optical film having a good light stability and hygrothermal durability, as a result of incorporating 1 to 20 parts by mass of a compound which contains three cyclic structures substituted on any one of benzene ring, cyclohexane ring and pyrimidine ring, pyridine ring, per 100 parts by mass of cellulose ester. Patent Literature 4 describes a cellulose acylate film which is successfully suppressed in moisture-dependent changes in retardation, as a result of incorporating a compound having a nucleic acid base skeleton such as purine base skeleton.

### CITATION LIST

### Patent Literature

### [Patent Literature 1] JP-A-2012-215817

### [Patent Literature 2] JP-A-2011-39304

### [Patent Literature 3] JP-A-2013-125180

### [Patent Literature 4] JP-A-2011-241379

### SUMMARY OF THE INVENTION

### Technical Problem

While the optical films described in Patent Literature 1 might have suppressed the environmental moisture-dependent changes in retardation, that is, moisture dependence, the film tends to result in larger changes in optical characteristics under hygrothermal conditions. While the optical films described in Patent Literature 2 might have achieved a good hygrothermal durability, the film, if in pursuit of necessary optical characteristics, will become thicker than 40 μm, since the partially ring-opened product of the styrene-maleic anhydride copolymer has a small intrinsic birefringence.

The optical film, if hopefully be thinned, needs be improved in developability of optical characteristics per unit thickness. It is, however, difficult to thin the film by improving the developability of optical characteristics per unit thickness as described above, and to suitably balance the moisture dependence with the optical stability under hygrothermal conditions.

On the other hand, the films described in Patent Literature 3 and Patent Literature 4 contain a compound having a condensed ring structure. The compound containing the condensed ring structure, however, tends to show an absorption peak shifted towards longer wavelength side. As a consequence, the film containing the compound having a condensed ring structure may be colored, or may show forward dispersion characteristic which means that the shorter the wavelength, the larger the retardation value.

This invention was conceived to solve the above-described problems, and is to provide an optical film which shows an improved developability of optical characteristics per unit thickness, and concurrently shows excellent moisture dependence and optical stability under hygrothermal conditions. This invention is also to provide a polarizing plate and a liquid crystal display device using such optical film.

### Solution to Problem

After intensive studies aimed at solving the above-described problems, the present inventors found out that an optical film, characterized by containing a cellulose acylate having a certain degree of acyl substitution, having a thicknesswise retardation Rth which satisfies certain conditions, and having a thickness of 40 μm or thinner, showed a good moisture dependence, and a good optical stability under hygrothermal conditions. The findings led us to propose this invention.

This invention is specifically configured as follows:

<1> An optical film comprising a cellulose acylate whose degree of substitution of acyl group is from 2.0 to 2.6, satisfying Formula 1 and Formula 2 below, and having a thickness of 40 μm or thinner;

ΔRth(RH)/Rth(550)≦0.12 Formula 1:

ΔRth(60° C.90% 1d)/Rth(550)≦0.05 Formula 2:

in the formulae,

ΔRth(RH)=Rth(30%)−Rth(80%),

wherein Rth(30%) representing thicknesswise retardation Rth of the optical film measured at a wavelength of 550 nm in a 25° C./30% relative humidity environment, after the optical film allowed to stand in a 25° C./30% relative humidity environment for 2 hours, and

Rth(80%) representing thicknesswise retardation Rth of the optical film measured at a wavelength of 550 nm in a 25° C./80% relative humidity environment, after the optical film allowed to stand in a 25° C./80% relative humidity environment for 2 hours; and

ΔRth(60° C.90% 1d)=Rth(60° C.90% 1d)−Rth(initial),

wherein Rth(initial) representing thicknesswise retardation Rth of the optical film, as bonded to a glass plate, measured at a wavelength of 550 nm after the optical film allowed to stand in a 25° C./60% relative humidity environment for 6 hours, and

Rth(60° C.90% 1d) representing thicknesswise retardation Rth of the optical film, as bonded to a glass plate, measured at a wavelength of 550 nm after the optical film allowed to stand in a 60° C., 90% relative humidity environment for 24 hours, and further in a 25° C./60% relative humidity environment for 6 hours, and

Rth(550) representing thicknesswise retardation of the optical film measured at a wavelength of 550 nm.

<2> The optical film of <1>, having a dimensional change rate of −0.5 to +0.5% between before and after the optical film allowed to stand in a 60° C./90% relative humidity environment for 24 hours, measured in the direction parallel to slow axis or in the direction perpendicular to the slow axis.
<3> The optical film of <1> or <2>, further satisfying Formula 3 below:

−2 nm≦ΔRe(λ)≦2 nm Formula 3:

wherein ΔRe(λ)=Re(630)−Re(450), Re(630) representing in-plane retardation at a wavelength of 630 nm, and Re(450) representing in-plane retardation at a wavelength of 450 nm.
<4> A polarizing plate having at least the optical film described in any one of <1> to <3>, and a polarizer.
<5> A polarizing plate comprising the optical film described in any one of <1> to <3>, a film having a moisture permeability of 100 g/m² or less after allowed to stand in a 40° C./90% relative humidity environment for 24 hours, and a polarizer held in between.
<6> The polarizing plate of <5>, wherein the film having a moisture permeability of 100 g/m² or less after allowed to stand in a 40° C./90% relative humidity environment for 24 hours, and the polarizer are bonded using an active energy curable adhesive.
<7> A liquid crystal display device comprising the optical film described in any one of <1> to <3>, or the polarizing plate described in any one of <4> to <6>.

Preferably, the optical film comprises a monocyclic compound represented by Formula (1) and/or a monocyclic compound represented by Formula (2) below:

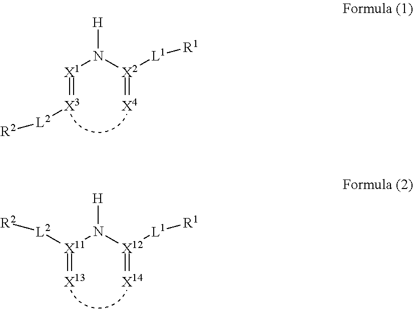

in the formulae, each of X¹ and X⁴ independently represents ═CH— or nitrogen atom, each of X² and X³ represents a carbon atom;
each of X¹¹ and X¹² represents a carbon atom, each of X¹³ and X¹⁴ independently represents ═CH— or nitrogen atom;
each of L¹ and L² independently represents a single bond, —CO—, —O—, —NR—, or any group formed by combining any of them, R represents a hydrogen atom, or alkyl group having 1 to 6 carbon atoms, each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms; and each dotted line represents a single bond, or an atomic group capable of forming a ring together with —X³(-L²-R²)═X¹—NH—X²(-L¹-R¹)═X⁴— or —X¹³═X¹¹(-L²-R²)—NH—X¹²(-L¹-R¹)═X¹⁴—.

Preferably, the monocyclic compound represented by Formula (1) and the monocyclic compound represented by Formula (2) are respectively a monocyclic compound represented by Formula (1-1) and a monocyclic compound represented by and Formula (2-1) below:

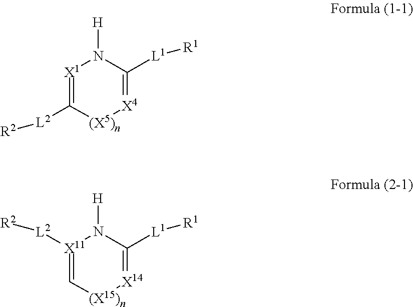

in the formulae, each of X¹ and X⁴ independently represents ═CH— or nitrogen atom, X⁵ represents —CH₂— or —NH—,
X¹¹ represents a carbon atom, X¹⁴ represents ═CH— or nitrogen atom, X¹⁵ represents —CH₂— or —NH—,
each of L¹ and L² independently represents a single bond, —CO—O—, —CO—NH—, or —NH—CO—,
each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms, and n represents an integer of 0 or 1.

Preferably, each of L¹ and L² in Formula (1-1) and Formula (2-1) represents a single bond.

Preferably, each of the monocycles in the monocyclic compound represented by Formula (1) and monocyclic compound represented by Formula (2) independently represents a pyrrole ring, pyrazole ring, imidazole ring or triazole ring.

### Advantageous Effects of Invention

According to this invention, there is provided an optical film which shows an improved developability of optical characteristics per unit thickness, and concurrently shows excellent moisture dependence and optical stability under hygrothermal conditions. According to this invention, there is also provided a polarizing plate and a liquid crystal display device using such optical film.

### DESCRIPTION OF EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

This invention will be detailed below. Explanation of constituent features will occasionally be made on representative embodiments or specific examples of this invention, to which this invention is by no means limited. In this specification, all numerical ranges expressed using “to” with preceding and succeeding numerals are defined to contain these numerals as the lower and upper limit values.

In this specification, Re(λ) and Rth(λ) represent in-plane retardation (nm) and thicknesswise retardation (nm), respectively, at a wavelength of 2. In this specification, the wavelength λ is 550 nm unless otherwise specifically noted. Re(λ) is measured using KOBRA 21ADH (from Oji Scientific Instruments), by making a light of λ nm in wavelength incident in the direction of normal line on the film. Measurement wavelength λ nm is selectable by manually exchanging the wavelength selective filter, or by programmed conversion of the measured value. In the calculation of Rth(λ), Re(λ) is measured while varying the angle of inclination of an incident light of λ nm in wavelength, over the range from the direction of normal line on the film up to 50° inclination on one side at 10-degree steps, at 6 points in total, assuming the in-plane slow axis (determined by KOBRA 21ADH) as the axis of inclination (axis of rotation) (for the film having no slow axis, an arbitrary in-plane direction is assumed as the axis of rotation), and Rth(λ) is then calculated by KOBRA 21ADH based on the thus-measured retardation values, a hypothetical value of average refractive index, and an entered value of thickness of film. Rth may alternatively be calculated by measuring retardation values in two arbitrarily-inclined directions while assuming the slow axis as the axis of inclination (axis of rotation) (for the film having no slow axis, an arbitrary in-plane direction is assumed as the axis of rotation), and Rth(λ) is then calculated based on the thus-measured retardation values, a hypothetical value of average refractive index, and an entered value of thickness of film, according to the Formula (A) and Formula (B) below. Now, the hypothetical value of average refractive index can be referred to Polymer Handbook (John Wiley & Sons, Inc.) and catalog-listed values of various optical films. For any optical film with the average refractive index thereof unknown, the average refractive index can be measured using an Abbe's refractometer. Values of the average refractive index of major optical films are given below: cellulose acylate (1.48), cycloolefin polymer (1.52), polycarbonate (1.59), poly(methyl methacrylate) (1.49), polystyrene (1.59). When entered with the hypothetical value of average refractive index and the thickness of film, KOBRA 21ADH calculates nx, ny and nz. Using such calculated nx, ny and nz, Nz=(nx−nz)/(nx−ny) is further calculated.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( A )$$

Now, Re(θ) represents a retardation value measured in the direction inclined by angle θ away from the normal line direction; nx, ny and nz represent refractive indices in the direction of the individual major axes, and d represents the thickness of the film.

Rth=((nx+ny)/2−nz)×d Formula (B)

The average refractive index n, necessary here as a parameter for the calculation, was obtained by measurement using an Abbe refractometer (Abbe refractometer 2-T, from Atago Co., Ltd.).

In this specification, Re(λ) and Rth(λ) values such as Re(450), Re(550), Re(630), Rth(450), Rth(550) and Rth(630) are determined by measurement, using a measuring instrument, at three or more different wavelengths (for example, λ=479.2 nm, 546.3 nm, 628.3 nm), and calculation based on the individual wavelength. That is, the obtained values are approximated by Cauchy's equation (up to the third term, such as Re=A+B/λ²+C/λ⁴) to determine values A, B and C. Using these values, Re and Rth at wavelength λ are re-plotted, and thereby Re(λ) and Rth(λ) at the individual wavelengths are determined.

The retardation may alternatively be measured using AxoScan (from Axometrics, Inc.).

Unless otherwise mentioned, Re(450), Re(550), Re(630), Rth(450), Rth(550) and Rth(630) are measured under an environment of 25° C. and 60% relative humidity.

### (Optical Film)

The optical film of this invention is characterized in that it comprises a cellulose acylate whose degree of substitution of acyl group is from 2.0 to 2.6, that it satisfies Formula 1 and Formula 2 below, and that it has a thickness of 40 μm or thinner;

ΔRth(RH)/Rth(550)≦0.12 Formula 1:

ΔRth(60° C.90% 1d)/Rth(550)≦0.05 Formula 2:

in the formulae,

ΔRth(RH)=Rth(30%)−Rth(80%),

wherein Rth(30%) representing thicknesswise retardation Rth of the optical film measured at a wavelength of 550 nm in a 25° C./30% relative humidity environment, after the optical film allowed to stand in a 25° C./30% relative humidity environment for 2 hours,

Rth(80%) representing thicknesswise retardation Rth of the optical film measured at a wavelength of 550 nm in a 25° C./80% relative humidity environment, after the optical film allowed to stand in a 25° C./80% relative humidity environment for 2 hours;

and

ΔRth(60° C.90% 1d)=Rth(60° C.90% 1d)−Rth(initial),

wherein Rth(initial) representing thicknesswise retardation Rth of the optical film, as bonded to a glass plate, measured at a wavelength of 550 nm after the optical film allowed to stand in a 25° C./60% relative humidity environment for 6 hours, and

Rth(60° C.90% 1d) representing thicknesswise retardation Rth of the optical film, as bonded to a glass plate, measured at a wavelength of 550 nm after the optical film allowed to stand in a 60° C., 90% relative humidity environment for 24 hours, and further in a 25° C./60% relative humidity environment for 6 hours, and

Rth(550) representing thicknesswise retardation of the optical film measured at a wavelength of 550 nm.

The optical film of this invention is usable as an optically compensatory film.

Since the optical film of this invention may be improved in developability of optical characteristics per unit thickness, so that the film may be thinned to 40 μm or below. The film is also excellent in moisture dependence and optical stability under hygrothermal conditions.

### <Physical Properties of Optical Film>

The optical film of this invention satisfies Formula 1 and Formula 2 below. The optical film of this invention preferably satisfy Formula 1-1 and Formula 2-1 below, and more preferably satisfy Formula 1-2 and Formula 2-2 below.

If Formula 1 and Formula 2 are not satisfied, the film will be unable to be thinned while improving the developability of optical characteristics per unit thickness, and will be unable to suitably balance the moisture dependence and optical stability under hygrothermal conditions.

ΔRth(RH)/Rth(550)≦0.12 Formula 1:

ΔRth(60° C.90% 1d)/Rth(550)≦0.05 Formula 2:

ΔRth(RH)/Rth(550)<0.10 Formula 1-1:

ΔRth(60° C.90% 1d)/Rth(550)≦0.04 Formula 2-1:

ΔRth(RH)/Rth(550)≦0.09 Formula 1-2:

ΔRth(60° C.90% 1d)/Rth(550)≦0.03 Formula 2-2:

In the formulae, ΔRth(RH)=Rth(30%)−Rth(80%),

wherein Rth(30%) representing thicknesswise retardation Rth of the optical film measured at a wavelength of 550 nm in a 25° C./30% relative humidity environment, after the optical film allowed to stand in a 25° C./30% relative humidity environment for 2 hours, and

Rth(80%) representing thicknesswise retardation Rth of the optical film measured at a wavelength of 550 nm in a 25° C./80% relative humidity environment, after the optical film allowed to stand in a 25° C./80% relative humidity environment for 2 hours;

and

ΔRth(60° C.90% 1d)=Rth(60° C.90% 1d)−Rth(initial),

wherein Rth(initial) representing thicknesswise retardation Rth of the optical film, as bonded to a glass plate, measured at a wavelength of 550 nm after the optical film allowed to stand in a 25° C./60% relative humidity environment for 6 hours, and

Rth(60° C.90% 1d) representing thicknesswise retardation Rth of the optical film, as bonded to a glass plate, measured at a wavelength of 550 nm after the optical film allowed to stand in a 60° C., 90% relative humidity environment for 24 hours, and further in a 25° C./60% relative humidity environment for 6 hours, and

Rth(550) representing thicknesswise retardation of the optical film measured at a wavelength of 550 nm.

The optical film which satisfies Formula 1 and Formula 2 above may be manufactured, for example, by adding additive(s) described later in this specification.

The optical film of this invention preferably satisfies Formula 3 below, more preferably satisfies Formula 3-1, and furthermore preferably satisfies Formula 3-2.

Hue change in oblique view may be improved by controlling ΔRe(λ) to −2 nm or above, and hue change due to widthwise and longitudinal variations in Re and Rth may be reduced by controlling ΔRe(λ) to 2 nm or below.

−2 nm≦ΔRe(λ)≦2 nm Formula 3:

−1.4 nm≦ΔRe(λ)≦2 nm Formula 3-1:

−1.4 nm≦ΔRe(λ)≦1.5 nm Formula 3-2:

ΔRe(λ)=Re(630)−Re(450), Re(630) represents in-plane retardation at a wavelength of 630 nm, and Re(450) represents in-plane retardation at a wavelength of 450 nm.

Preferable ranges of Rth(30%), Rth(80%), Rth(550), Rth(60° C.90% 1d), Rth(initial), Re(630), Re(550), and Re(450) are given as below:

100 nm≦Rth(30%)≦280 nm

90 nm≦Rth(80%)≦250 nm

100 nm≦Rth(550)≦250 nm

90 nm≦Rth(60° C.90% 1d)≦260 nm

100 nm≦Rth(initial)≦250 nm

30nm≦Re(630)≦100nm

30 nm≦Re(550)≦100 nm

30nm≦Re(450)≦100nm

The optical film of this invention preferably shows a dimensional change rate of −0.5 to +0.5% between before and after allowed to stand in a 60° C./90% relative humidity environment for 24 hours, when measured in the direction parallel to the slow axis or in the direction perpendicular to the slow axis, more preferably −0.3 to +0.3%, and furthermore preferably −0.2 to +0.2%. By controlling the dimensional change rate within the above-described ranges, the moisture dependence, and optical stability under hygrothermal conditions may further be improved.

The dimensional change rate may be measured specifically by the method below. First, prepared is a sample of 25 cm long (in the direction of measurement) and 5 cm wide cut from the film, or, a sample cut from the film so as to align the longitudinal direction to the direction perpendicular thereto. The sample is pierced to form pinholes at a 20 cm interval, allowed to be conditioned at 25° C., 60% relative humidity for 24 hours, and then measured regarding the distance between the pinholes using a pin gauge (measured value denoted by L₀). Next, the sample is kept under a hot and humid environment at 60° C., 90% relative humidity for 24 hours, further conditioned at 25° C., 60% relative humidity for 2 hours, and the distance between the pinholes are again measured using the pin gauge (measured value denoted by L₁). Using these measured values, the dimensional change rate may be calculated according to the equation below.

Dimensional change rate [%]=(L₁−L₀)/L₀}×100

The optical film of this invention preferably has a thickness of 40 μm or thinner, preferably 38 μm or thinner, and furthermore preferably 35 μm or thinner. The lower limit is preferably 5 μm, but not specifically limited thereto.

### <Cellulose Acylate>

The optical film of this invention contains cellulose acylate whose degree of substitution of acyl group is from 2.0 to 2.6.

Cellulose used as a raw material of cellulose acylate includes cotton linter and wood pulp (hardwood pulp, softwood pulp). Cellulose acylate obtained from whichever source cellulose is usable, and a plurality of the cellulose acylate may be used in a mixed manner on occasions. These source celluloses are detailed, for example, in “Purasuchikkku Zairyo Koza (17), Sen′iso-kei Jushi, in Japanese, (“A Course of Plastic Material (17), Cellulose-Base Resin”), by Marusawa and Uda, published by Nikkan Kokyo Shimbun, Ltd. (1970), or Journal of Technical Disclosure No. 2001-1745, p. 7-8, published by Japan Institute of Invention and Innovation.

β-1,4-Bonded glucose unit composing cellulose have free hydroxy groups on the 2-, 3- and 6-positions. The cellulose acylate is a polymer obtained by acylating a part of, or all of, the hydroxy groups with acyl groups. The degree of substitution of acyl group means the total of percentages of acylation of hydroxy groups bound to the 2-, 3-, and 6-positions (100% acylation at the individual positions gives a degree of substitution of 1).

In this invention, the degree of substitution of acyl group in the cellulose acylate is 2.0 to 2.6, preferably 2.0 to 2.5, and furthermore preferably 2.1 to 2.4.

It is preferable that 90% by mass or more, preferably 95% by mass or more, furthermore preferably 96% by mass or more, and particularly all, of the cellulose acylate to be used satisfies the above-described degree of substitution of acyl group.

Acyl group used for acylation of the cellulose may be a single species of acyl group, or two or more species of acyl group. The acyl group preferably has two or more carbon atoms.

The acyl group of the cellulose acylate, having two or more carbon atoms, may be an aliphatic group or may be an aryl group, without special limitation. Specific examples include alkylcarbonyl ester, alkenylcarbonyl ester or aromatic carbonyl ester, and aromatic alkylcarbonyl ester of cellulose, wherein each of them may further have a substituent. Preferable examples include acetyl group, propionyl group, butanoyl group, heptanoyl group, hexanoyl group, octanoyl group, decanoyl group, dodecanoyl group, tridecanoyl group, tetradecanoyl group, hexadecanoyl group, octadecanoyl group, isobutanoyl group, tert-butanoyl group, cyclohexanecarbonyl group, oleoyl group, benzoyl group, naphthyl carbonyl group, and cinnamoyl group. Among them, more preferable examples include acetyl group, propionyl group, butanoyl group, dodecanoyl group, octadecanoyl group, tert-butanoyl group, oleoyl group, benzoyl group, naphthyl carbonyl group, and cinnamoyl group; and particularly preferable examples include acetyl group, propionyl group, butanoyl group (the case where the acyl group has 2 to 4 carbon atoms); and further particularly preferable examples include acetyl group (the case where the cellulose acylate is cellulose acetate).

When acid anhydride or acid chloride is used as an acylation agent in the acylation of cellulose, organic solvent usable as a reaction solvent is exemplified by organic acids such as acetic acid and methylene chloride.

As a catalyst, a protic catalyst such as sulfuric acid is preferably used when acid anhydride is used as the acylating agent, meanwhile a basic compound is preferably used when acid chloride (CH₃CH₂COCl, for example) is used as the acylating agent.

Most general industrial synthetic methods of mixed fatty acid ester of cellulose include a method of acylating cellulose using a mixture of organic acid components which contain fatty acid corresponding to acetyl group and other acyl group (acetic acid, propionic acid, valeric acid, etc.) or acid anhydrides thereof.

The cellulose acylate used in this invention may be synthesized according to a method described, for example, in JP-A-H10-45804.

The content of the cellulose acylate in the optical film of this invention is preferably 70% by mass or more of the mass of optical film, more preferably 75% by mass or more, more preferably 80% by mass or more, and particularly 85% by mass or more.

### <Additive>

The optical film of this invention may comprise any additive, besides the cellulose acylate. The additive is exemplified by monocyclic compounds represented by Formula (1) and Formula (2), and plasticizer (for example, sugar ester compound, ester-base compound, etc.).

### <<Monocyclic Compound Represented by Formula (1) or Formula (2)>>

The optical film of this invention preferably comprises a monocyclic compound represented Formula (1) below and/or a monocyclic compound represented by Formula (2).

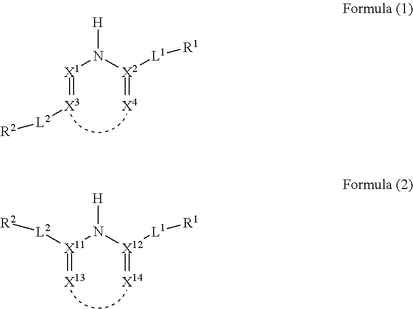

In the formulae, each of X¹ and X⁴ independently represents ═CH— or nitrogen atom, each of X² and X³ represents a carbon atom;

Each of X¹¹ and X¹² represents a carbon atom, each of X¹³ and X¹⁴ independently represents ═CH— or nitrogen atom;

each of L¹ and L² independently represents a single bond, —CO—, —O—, —NR—, or any group formed by combining any of them, where R represents a hydrogen atom, or an alkyl group having 1 to 6 carbon atoms; each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms; and each dotted line represents a single bond, or an atomic group capable of forming a ring together with —X³(-L²-R²)═X¹—NH—X²(-L¹-R¹)═X⁴— or —X¹³═X¹¹(-L²-R²)—NH—X¹²(-L¹-R¹)═X¹⁴—.

From the viewpoint of further improving the devlopability of optical characteristics per unit thickness, and of further improving the moisture dependence and optical stability under hygrothermal conditions, the optical film of this invention preferably comprises a monocyclic compound represented by Formula (1) and/or a monocyclic compound represented by Formula (2).

The reason why the effect of this invention may further be enhanced, by incorporating the monocyclic compound represented by Formula (1) and/or the monocyclic compound represented by Formula (2), is supposed as follows.

This is supposedly because an acidic hydrogen in the compound represented by Formula (1) or Formula (2) can selectively coordinates to a carbonyl group. When given a form of cyclic compound, angle of bond between the nitrogen atom and the neighboring atom may be fixed, and this reduces steric hindrance around the acidic hydrogen and allows the acidic hydrogen to more smoothly coordinate to the carbonyl group. It has also become clear that the compound represented by Formula (1) and a heteroaromatic compound represented by Formula (2) are particularly preferable, for the purpose of increasing the developability of optical characteristics.

In Formula (1), each of X¹ and X⁴ independently represents ═CH— or nitrogen atom, and each of X² and X³ represents a carbon atom.

In Formula (1), each of L¹ and L² independently represents a single bond, —CO—, —O—, —NR—, or groups formed by combining any of them, wherein a group formed by combining a single bond, —CO— and —O—, and a group formed by combining —CO— and —NR— are preferable, and both of L¹ and L² are more preferably single bonds.

R represents a hydrogen atom, or alkyl group having 1 to 6 carbon atoms. The alkyl group having 1 to 6 carbon atoms is preferably an alkyl group having 1 to 4 carbon atoms, and more preferably an alkyl group having 1 to 3 carbon atoms. The alkyl group having 1 to 6 carbon atoms is exemplified by methyl group, ethyl group, propyl group, isopropyl group, butyl group, t-butyl group, pentyl group, neopentyl group, hexyl group, and cyclohexyl group. R preferably represents a hydrogen atom.

In Formula (1), each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms.

The optionally-substituted cycloalkyl group having 5 to 10 carbon atoms is preferably cycloalkyl group having 5 to 8 carbon atoms, and more preferably cycloalkyl group having 5 or 6 carbon atoms. The cycloalkyl group having 5 to 10 carbon atoms is exemplified by cyclopentyl group, cyclohexyl group, cycloheptyl group, cyclooctyl group, cyclononyl group, and cyclodecyl group.

The optionally-substituted aryl group having 6 to 20 carbon atoms is preferably aryl group having 6 to 14 carbon atoms, and more preferably aryl group having 6 to 10 carbon atoms. The aryl group having 6 to 20 carbon atoms is exemplified by phenyl group, naphthyl group, and anthracenyl group.

When the aryl group has plural rings, the carbon number is preferably 9 to 18. An aryl group having a carbon number of 11 to 16 is more preferred. It is preferred that hetero ring is contained as a part of the plural rings.

The optionally-substituted heterocyclic group having 3 to 10 carbon atoms is preferably heterocyclic group having 3 to 7 carbon atoms, and is more preferably heterocyclic group having 3 to 5 carbon atoms. The heterocyclic group having 3 to 10 carbon atoms preferably has aromaticity. Heterocycle having aromaticity is generally unsaturated heterocycle, and is preferably heterocycle having a largest possible number of heterocycle. The heterocycle is preferably five-membered ring, six-membered ring or seven-membered ring, more preferably five-membered ring or six-membered ring, and most preferably six-membered ring. Hetero atom in the heterocycle is preferably nitrogen atom, sulfur atom or oxygen atom, and particularly nitrogen atom. As the heterocycle having aromaticity, pyridine ring (2-pyridyl or 4-pyridyl, when referred to as a heterocyclic group) is particularly preferable.

The cycloalkyl group having 5 to 10 carbon atoms, the aryl group having 6 to 20 carbon atoms, and the heterocyclic group having 3 to 10 carbon atoms may have a substituent. Examples of the substituent include halogen atom, hydroxyl group, cyano group, nitro group, carboxyl group, alkyl group (methyl group, ethyl group, propyl group, butyl group, pentyl group, etc.), alkenyl group, aryl group, alkoxy group (methoxy group, ethoxy group, propoxy group, butoxy group, etc.), alkenyloxy group, aryloxy group, acyloxy group, alkoxycarbonyl group, alkenyloxycarbonyl group, aryloxycarbonyl group, sulfamoyl group, alkyl-substituted sulfamoyl group, alkenyl-substituted sulfamoyl group, aryl-substituted sulfamoyl group, sulfonamide group, carbamoyl, alkyl-substituted carbamoyl group, alkenyl-substituted carbamoyl group, aryl-substituted carbamoyl group, amide group, alkylthio group, alkenylthio group, arylthio group, 2-thiophenyl group, 2-pyrrolyl group and acyl group.

In Formula (1), the dotted line indicates a single bond, or an atomic group which forms a ring together with —X³(-L²-R²)═X¹—NH—X²(-L¹-R¹)═X⁴—.

The atomic group is exemplified by —CH₂—, —NH—, —CH(-L¹-R¹)— (in the formula, L¹ and R¹ are synonymous to those described above, with the same preferable ranges), and groups formed by combining any of them, wherein single bond or —CH₂— is preferable, and single bond is more preferable.

The atomic group is preferably configured so as to give the compound represented by Formula (1) as a five- to seven-membered ring, more preferably configured to form a five-membered ring or six-membered ring, and furthermore preferably configured to form a five-membered ring. The five-membered ring is exemplified by pyrrole ring, pyrazole ring, imidazole ring and triazole ring.

In Formula (2), each of X¹¹ and X¹² represents a carbon atom, and each of X¹³ and X¹⁴ independently represents ═CH— or nitrogen atom.

In Formula (2), each of L¹ and L² independently represents a single bond, —CO—, —O—, —NR—, and groups formed by combining any of them, which are synonymous to L¹ and L² in Formula (1), and to R, with the same preferable ranges.

In Formula (2), each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms, which are synonymous to R¹ and R² in Formula (1), with the same preferable ranges.

In Formula (2), the dotted line indicates a single bond, or an atomic group capable of forming a ring together with —X¹³═X¹¹(-L²-R²)—NH—X¹²(-L¹-R¹)═X¹⁴—.

Definition of the atomic group is synonymous to that of the dotted line in Formula (1), with the same preferable ranges.

The atomic group is preferably configured so as to give the compound represented by Formula (2) as a five- to seven-membered ring, more preferably configured to form a five-membered ring or six-membered ring, and furthermore preferably configured to form a five-membered ring. The five-membered ring is exemplified by pyrrole ring, pyrazole ring, imidazole ring and triazole ring.

The monocyclic compound represented by Formula (1) and monocyclic compound represented by Formula (2) are preferably a monocyclic compound represented by Formula (1-1) below and a monocyclic compound represented by Formula (2-1) below, respectively

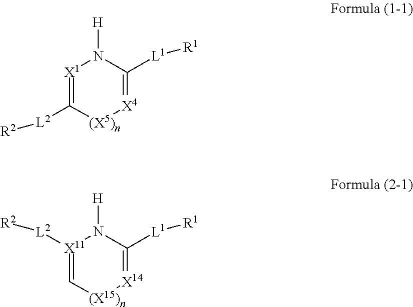

In the formulae, each of X¹ and X⁴ independently represents ═CH— or nitrogen atom, X⁵ represents —CH₂— or —NH—, X¹¹ represents a carbon atom, X¹⁴ represents ═CH— or nitrogen atom, X¹⁵ represents —CH₂— or —NH—, each of L¹ and L² independently represents a single bond, —CO—O—, —CO—NH—, or —NH—CO—, each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms, and n represents an integer of 0 or 1.

In Formula (1-1) and Formula (2-1), each of L¹ and L² independently represents a single bond, —CO—O—, —CO—NH—, or —NH—CO—, and particularly a single bond.

In Formula (1-1) and Formula (2-1), each of R¹ and R² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms, and are synonymous to R¹ and R² in Formula (1), with the same preferable ranges.

In Formula (1-1) and Formula (2-1), n represents an integer of 0 or 1, where 0 is preferable.

Specific examples of the monocyclic compound represented by Formula (1) and the monocyclic compound represented by Formula (2) are enumerated below, without limiting this invention. In the formulae, each of Ar¹ and Ar² independently represents an optionally-substituted cycloalkyl group having 5 to 10 carbon atoms, optionally-substituted aryl group having 6 to 20 carbon atoms, or optionally-substituted heterocyclic group having 3 to 10 carbon atoms.

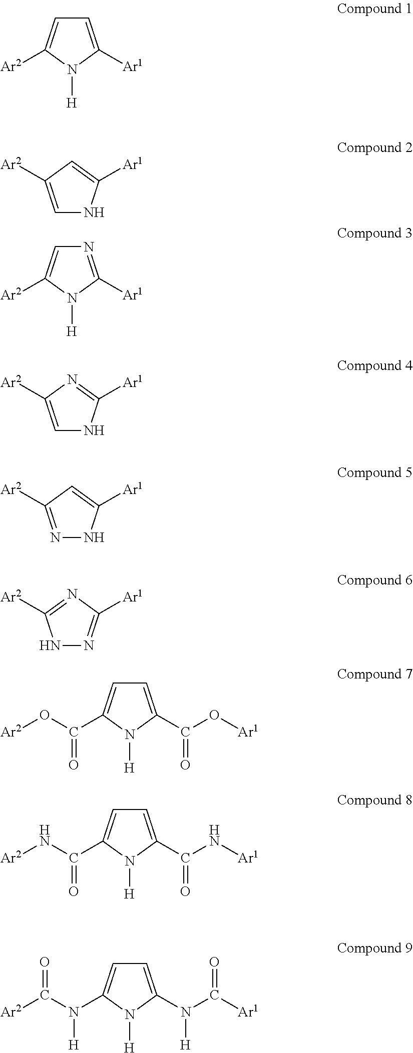

TABLE 1

| | Cyclic | | |
|---|---|---|---|
| | skeleton | | |
| | containing | | |
| | formula | | |
| | (1-1) or (2-1) | Ar¹ | Ar² |
| Compound 1-a | Compound 1 | Phenyl group | Phenyl group |
| Compound 2-a | Compound 2 | Phenyl group | Phenyl group |
| Compound 3-a | Compound 3 | Phenyl group | Phenyl group |
| Compound 4-a | Compound 4 | Phenyl group | Phenyl group |
| Compound 5-a | Compound 5 | Phenyl group | Phenyl group |
| Compound 6-a | Compound 6 | Phenyl group | Phenyl group |
| Compound 7-a | Compound 7 | Phenyl group | Phenyl group |
| Compound 8-a | Compound 8 | Phenyl group | Phenyl group |
| Compound 9-a | Compound 9 | Phenyl group | Phenyl group |
| Compound 1-b | Compound 1 | 4-Butoxyphenyl | 4-Butoxyphenyl group |
| | | group | |
| Compound 6-b | Compound 6 | 4-Butoxyphenyl | 4-Butoxyphenyl group |
| | | group | |
| Compound 1-c | Compound 1 | 4-Pentylphenyl | 4-Pentylphenyl group |
| | | group | |
| Compound 6-c | Compound 6 | 4-Pentylphenyl | 4-Pentylphenyl group |
| | | group | |
| Compound 8-c | Compound 8 | 4-Pentylphenyl | 4-Pentylphenyl group |
| | | group | |
| Compound 1-d | Compound 1 | 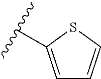 [SMILES: *c1cccs1] | 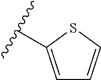 [SMILES: *c1cccs1] |
| Compound 1-e | Compound 1 | 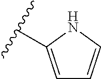 [SMILES: *c1ccc[nH]1] | 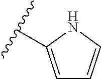 [SMILES: *c1ccc[nH]1] |
| Compound 5-b | Compound 5 | Phenyl group | 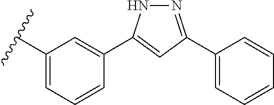 [SMILES: *c1cccc(-c2cc(-c3ccccc3)n[nH]2)c1] |

The amount of addition of the monocyclic compound represented by Formula (1) and the monocyclic compound represented by Formula (2), per 100 parts by mass of the cellulose acylate 100, is preferably 1 to 10 parts by mass, more preferably 1 to 7 parts by mass, and furthermore preferably 2 to 5 parts by mass. The monocyclic compound represented by Formula (1) and monocyclic compound represented by Formula (2) may be used independently, or two or more species thereof may be combined. When two or more species are mixed, the total amount falls in the above-described ranges.

The monocyclic compound represented by Formula (1) and the monocyclic compound represented by Formula (2) may be synthesized according to, for example, methods described in literatures below.
Compound 1-a may be synthesized according to a synthetic method described in J. Chem. Soc., Perkin Trans., 1, 1997, 3189-3196.
Compound 3-a may be synthesized according to a synthetic method described in J. Am. Chem. Soc., 2003, 125, 10580-10585.
Compound 6-a may be synthesized according to a synthetic method described in Bioorganic & Medicinal Chemistry, 2010, 18, 6184-6196.

### (Sugar Ester Compound)

The optical film of this invention may contain a sugar ester compound. The sugar ester compound preferably used here is an ester compound having 1 to 12 units of at least either one of pyranose structure and furanose structure, and having a part of OH groups in the structure esterified, and/or mixture of such compounds.

In the ester compound having 1 to 12 units of at least either one of pyranose structure and furanose structure, and having all of, or a part of, OH groups in the structure esterified, the ratio of esterification is preferably 70% or more of OH groups which reside in the pyranose structure or furanose structure.

In the present invention, the aforementioned ester compound is collectively referred to as sugar ester or sugar ester compound.

The ester compound usable in this invention is exemplified by, but not limited to, glucose, galactose, mannose, fructose, xylose, arabinose, lactose, sucrose, nystose, 1F-fructosyl nystose, stachyose, maltitol, lactitol, lactulose, cellobiose, maltose, cellotriose, maltotriose, raffinose and kestose.

Also gentiobiose, gentiotriose, gentiotetraose, xylotriose, and galactosyl sucrose are exemplified.

Among these compounds, compounds having both of the pyranose structure and the furanose structure are particularly preferable.

Such compounds are preferably exemplified by sucrose, kestose, nystose, 1F-fructosyl nystose, and stachyose; and more preferably sucrose.

The monocarboxylic acid used for esterifying all of, or a part of, OH groups in the pyranose structure or furanose structure is selectable from known aliphatic monocarboxylic acid, alicyclic monocarboxylic acid, aromatic monocarboxylic acid and so forth, without special limitation. The carboxylic acid to be used here may be a single species, or any mixture of two or more species.

Preferable examples of the aliphatic monocarboxylic acid include saturated fatty acids such as acetic acid, propionic acid, butyric acid, isobutyric acid, valeric acid, caproic acid, enanthic acid, caprylic acid, peralgonic acid, capric acid, 2-ethyl-hexane carboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid; and unsaturated fatty acids such as undecylenic acid, oleic acid, sorbic acid, linoleic acid, linolenic acid, arachidonic acid, and octenoic acid.

Preferable examples of the alicyclic monocarboxylic acid include acetic acid, cyclopentane carboxylic acid, cyclohexane carboxylic acid, cyclooctane carboxylic acid, and derivatives of them.

Preferable examples of the aromatic monocarboxylic acid include benzoic acid; aromatic monocarboxylic acids configured by introducing an alkyl group or alkoxy group into the benzene ring of benzoic acid, such as toluic acid; cinnamic acid; aromatic monocarboxylic acids having two or more benzene rings, such as benzilic acid, biphenyl carboxylic acid, naphthalene carboxylic acid, and tetralin carboxylic acid; and derivatives of them. More specifically, exemplified are xylic acid, hemellitic acid, mesitylenic acid, prehnitylic acid, γ-isodurylic acid, durylic acid, mesitoic acid, α-isodurylic acid, cuminic acid, α-toluic acid, hydroatropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthaloic acid, and p-coumaric acid. Benzoic acid and naphthyl acid are particularly preferable.

Ester compound of oligosaccharide is usable as the compound having 1 to 12 units of at least one of pyranose structure or furanose structure.

The oligosaccharide is manufactured by allowing an enzyme such as amylase to act on starch, sucrose or the like. The oligosaccharide applicable to this invention is exemplified by maltooligosaccharide, isomaltooligosaccharide, fructooligosaccharide, galactooligosaccharide, and xylooligosaccharide.

The sugar ester compound is a compound obtained by condensing 1 or more and 12 or less units of at least either one of pyranose structure or furanose structure represented by Formula (A) below, where each of R₁₁ to R₁₅, and each of R₂₁ to R₂₅ represents an acyl group having 2 to 22 carbon atoms, or a hydrogen atom, each of m and n independently represents an integer of 0 to 12, and (m+n) represents an integer of 1 to 12.

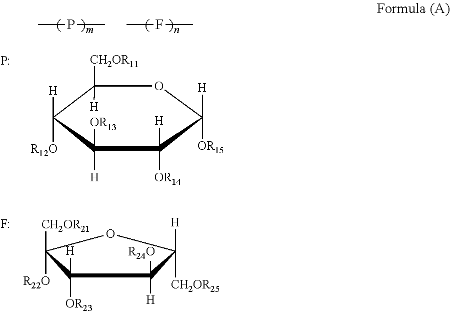

Each of R₁₁ to R₁₅, and each of R₂₁ to R₂₅ is preferably a benzoyl group, hydrogen atom, or acetyl group. The benzoyl group and acetyl group may further have substituent R₂₆, such as alkyl group, alkenyl group, alkoxy group and phenyl group, wherein such alkyl group, alkenyl group and phenyl group may further have a substituent. Also oligosaccharide may be manufactured in the same way as the sugar ester compound described above.

Specific examples of the sugar ester compound are enumerated below, but not limited thereto.

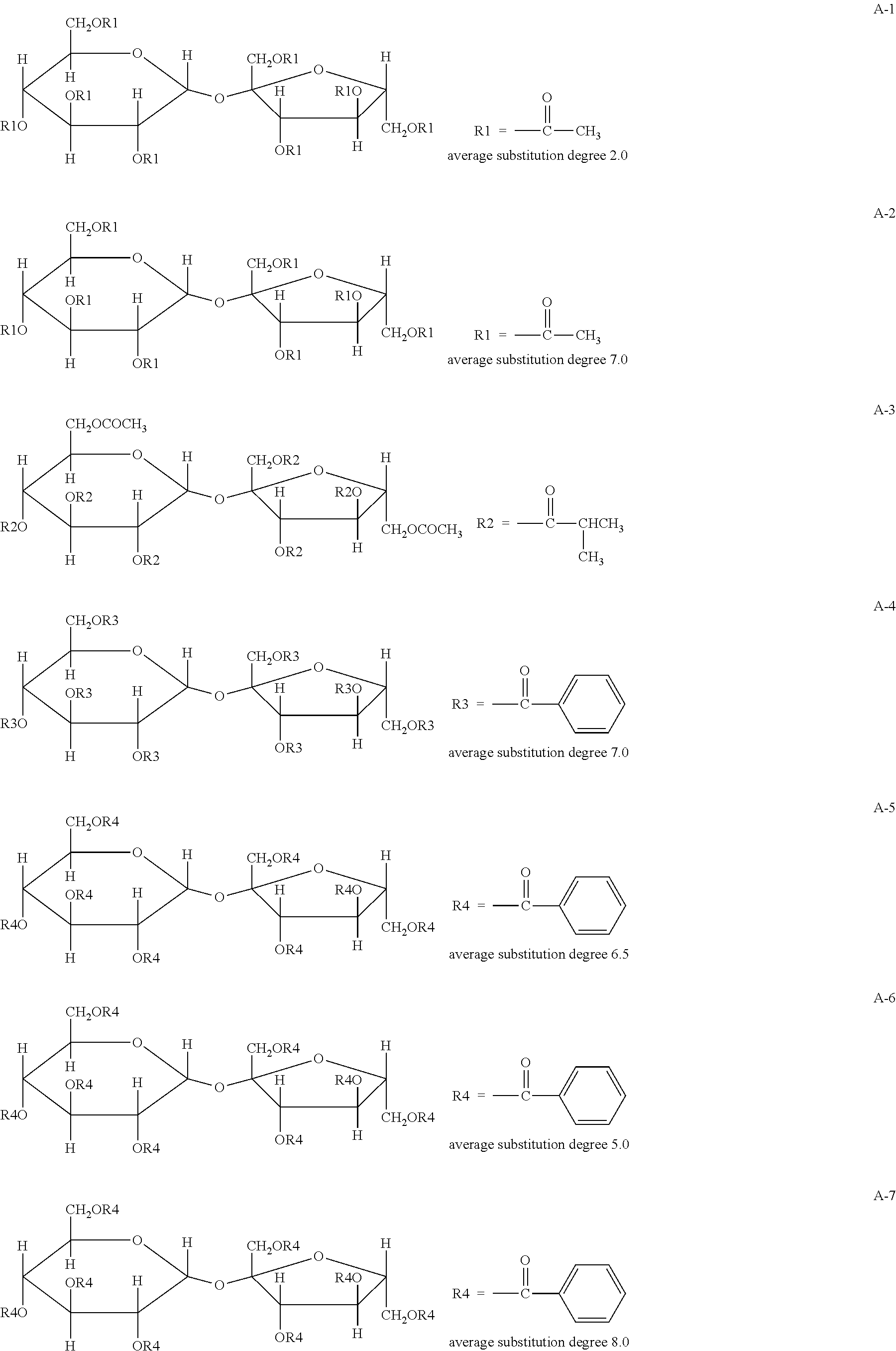

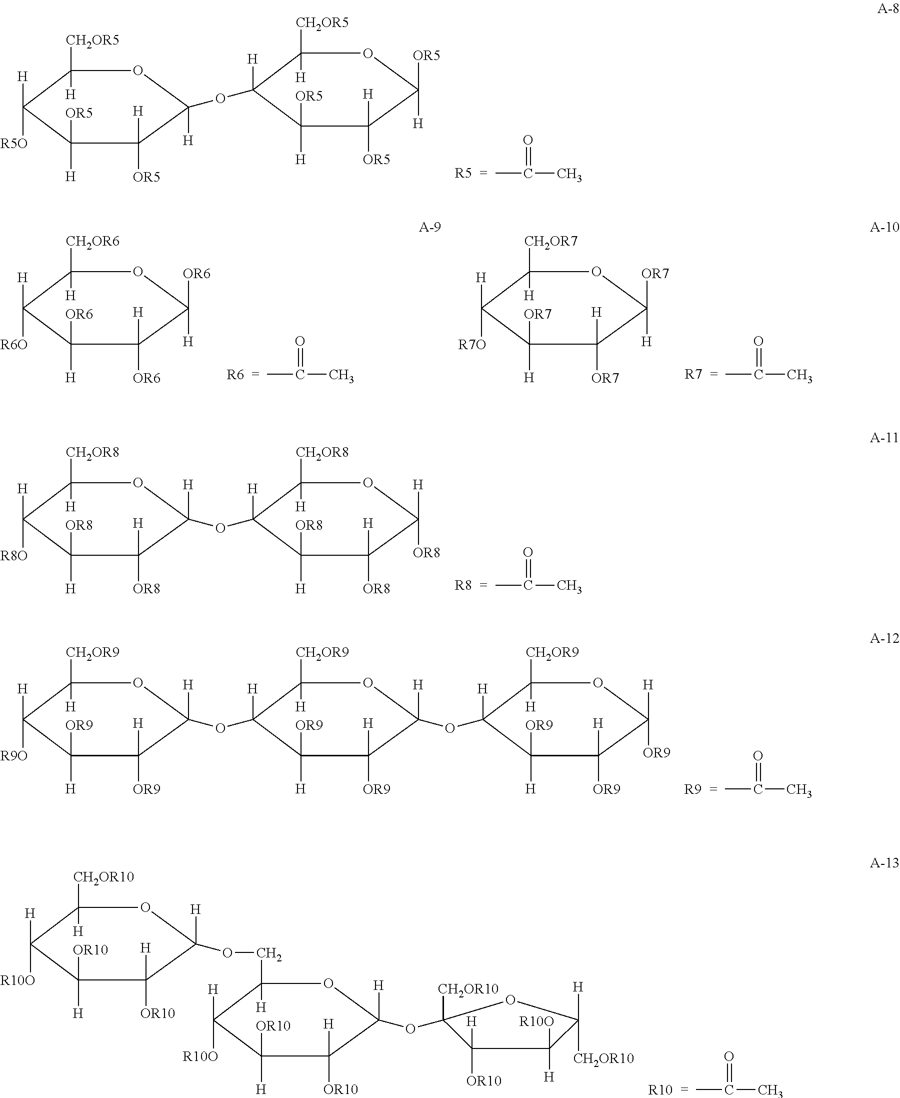

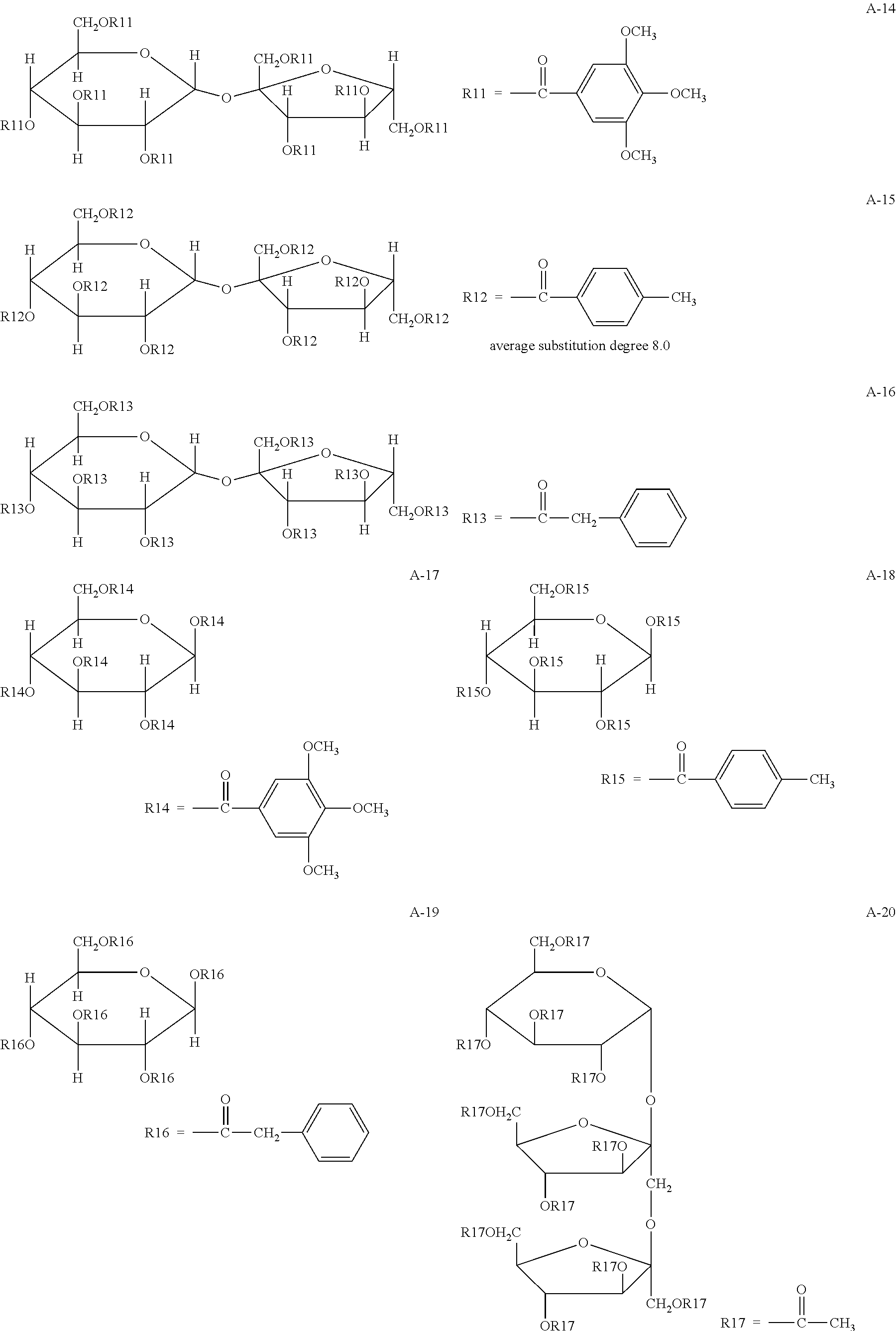

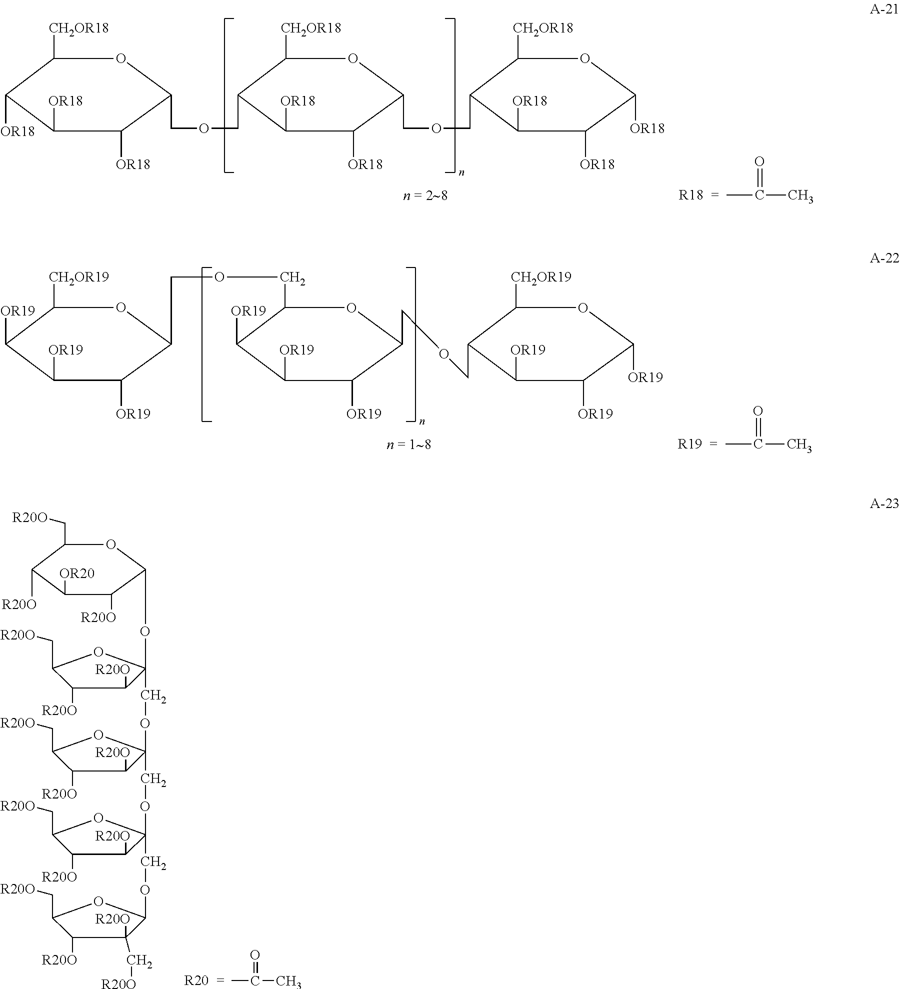

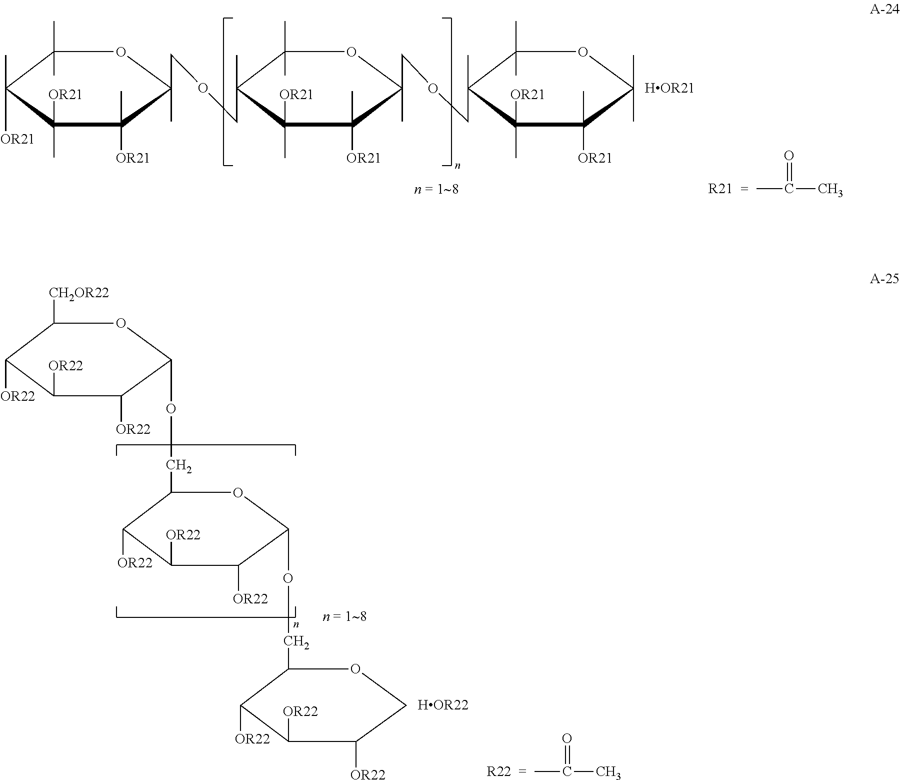

When the optical film of this invention contains the sugar ester compound, the content of the sugar ester compound is preferably 0.5 to 30% by mass relative to the mass of cellulose acylate, and is more preferably 2 to 15% by mass.

### <<Ester-Base Compound>>

The optical film of this invention may comprise an ester-base compound represented by Formula (10) below:

B-(G-A)ₙ-G-B Formula (10):

(in the formula, B represents a hydroxy group or carboxylic acid residue, G represents an alkylene glycol residue having 2 to 12 carbon atoms or an aryl glycol residue having 6 to 12 carbon atoms or an oxyalkylene glycol residue having 4 to 12 carbon atoms; A represents an alkylenedicarboxylic acid residue having 4 to 12 carbon atoms or an aryldicarboxylic acid residue having 6 to 12 carbon atoms; and n represents an integer of 1 or larger.)

The ester-base compound represented by Formula (10) is configured by a hydroxy group or carboxylic acid residue represented by B; an alkylene glycol residue or oxyalkylene glycol residue or arylglycol residue represented by G; and an alkylenedicarboxylic acid residue or aryldicarboxylic acid residue represented by A, and is obtainable by a reaction same as that for obtaining general ester-base compound.

The carboxylic acid component of the ester-base compound represented by Formula (10) is exemplified by acetic acid, propionic acid, butyric acid, benzoic acid, p-tert-butylbenzoic acid, o-toluic acid, m-toluic acid, p-toluic acid, dimethylbenzoic acid, ethylbenzoic acid, n-propylbenzoic acid, aminobenzoic acid, acetoxybenzoic acid, and aliphatic acid. These compounds may be used independently, or two or more species may be used in the form of mixture.

The alkylene glycol component, having 2 to 12 carbon atoms, of the ester-base compound represented by Formula (10) is exemplified by ethylene glycol, 1,2-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, and 1,12-octadecanediol. These glycols may be used independently, or two or more species may be used in the form of mixture.

The alkylene glycol having 2 to 12 carbon atoms is particularly preferable, by virtue of its excellent compatibility with the cellulose acylate.

The oxyalkylene glycol component, having 4 to 12 carbon atoms, of the ester-base compound represented by Formula (10) is exemplified by diethylene glycol, triethylene glycol, tetraethylene glycol, dipropylene glycol, and tripropylene glycol. These glycols may be used independently, or two or more species may be used in the form of mixture.

The alkylenedicarboxylic acid component, having 4 to 12 carbon atoms, of the ester-base compound represented by Formula (10) is exemplified by succinic acid, maleic acid, fumaric acid, glutaric acid, adipic acid, azelaic acid, sebacic acid, and dodecanedicarboxylic acid. These compounds may be used independently, or two or more species may be used in the form of mixture. The arylene dicarboxylic acid component having 6 to 12 atoms is exemplified by phthalic acid, terephthalic acid, isophthalic acid, 1,5-naphthalenedicarboxylic acid, and 1,4-naphthalenedicarboxylic acid.

The ester-base compound represented by Formula (10) preferably has a number-average molecular weight of 300 to 1500, and more preferably 400 to 1000. The ester-base compound preferably has an acid value of 0.5 mgKOH/g or less, and a hydroxy value of 25 mgKOH/g or less; and more preferably has an acid value of 0.3 mgKOH/g or less, and a hydroxy value of 15 mgKOH/g or less.

Specific examples of the ester-base compound represented by Formula (10), usable in this invention, are enumerated below, without limiting this invention.

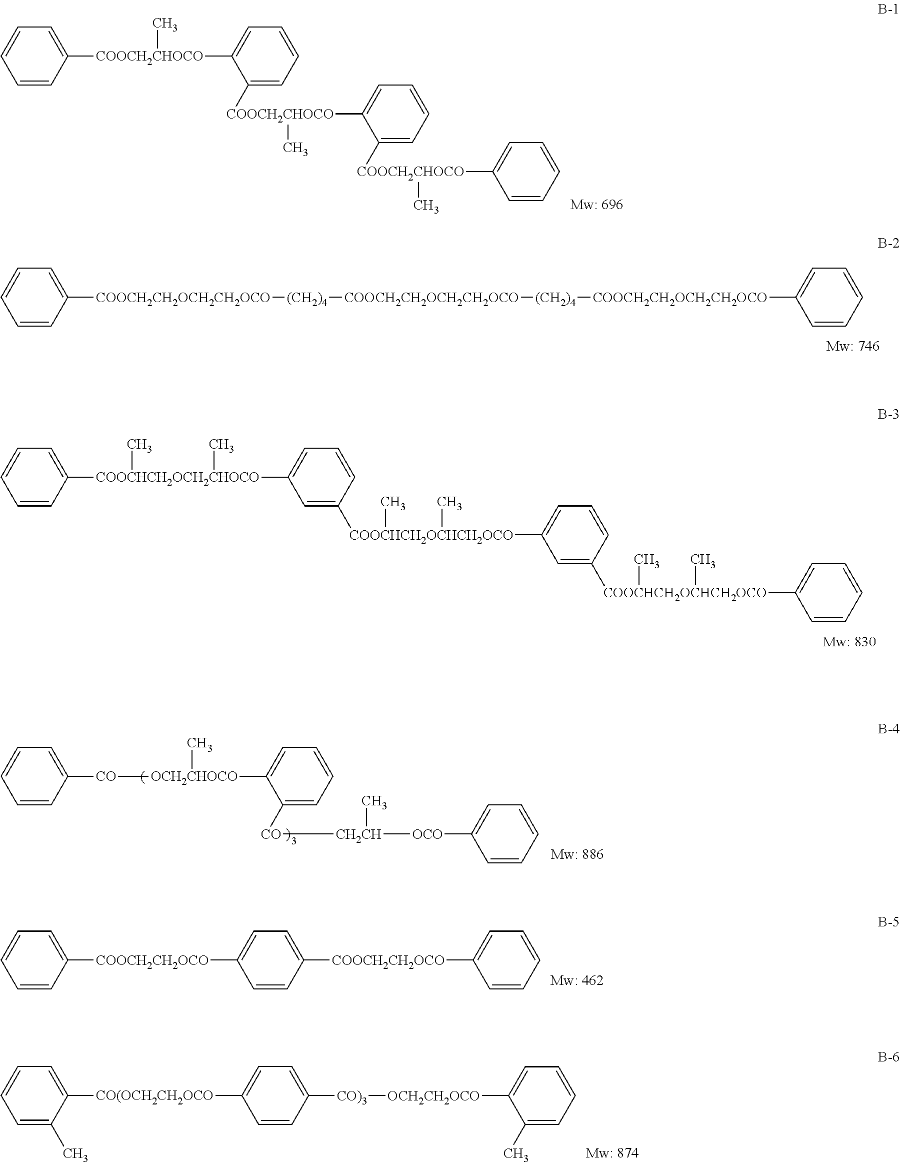

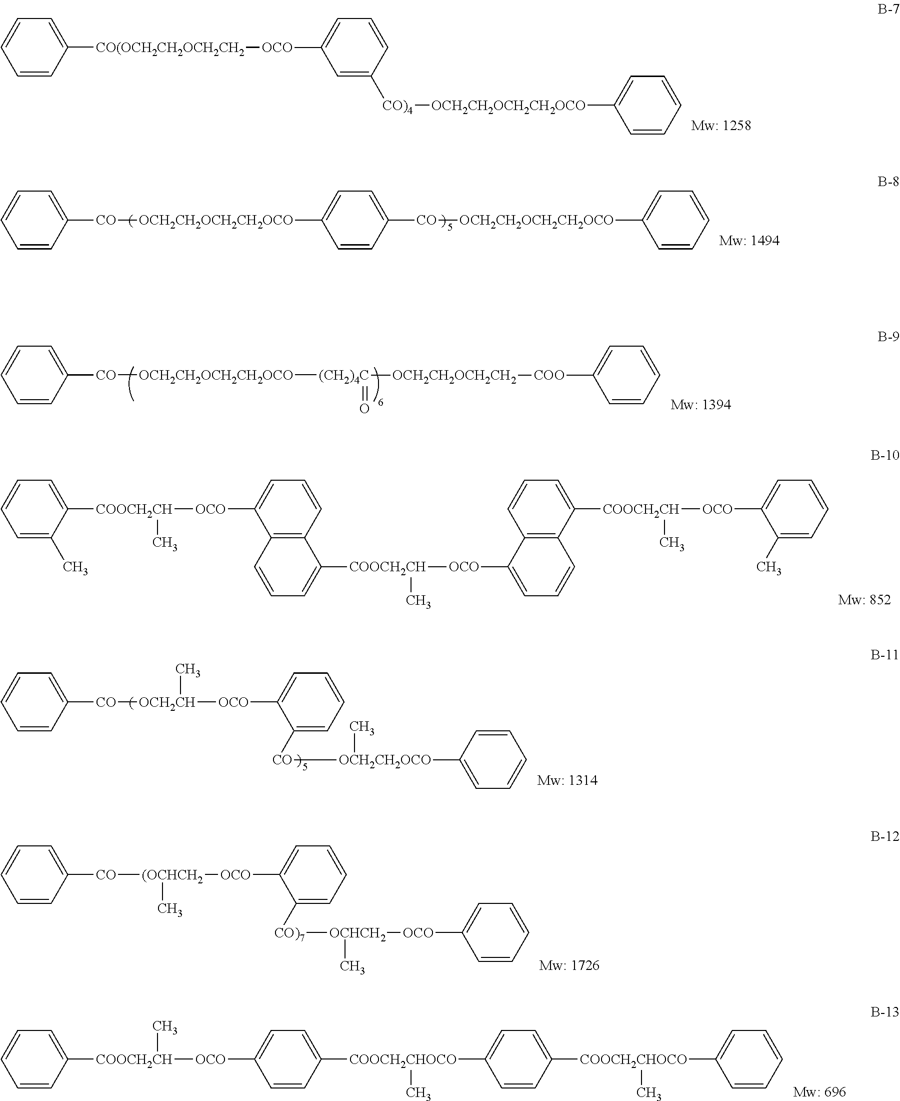

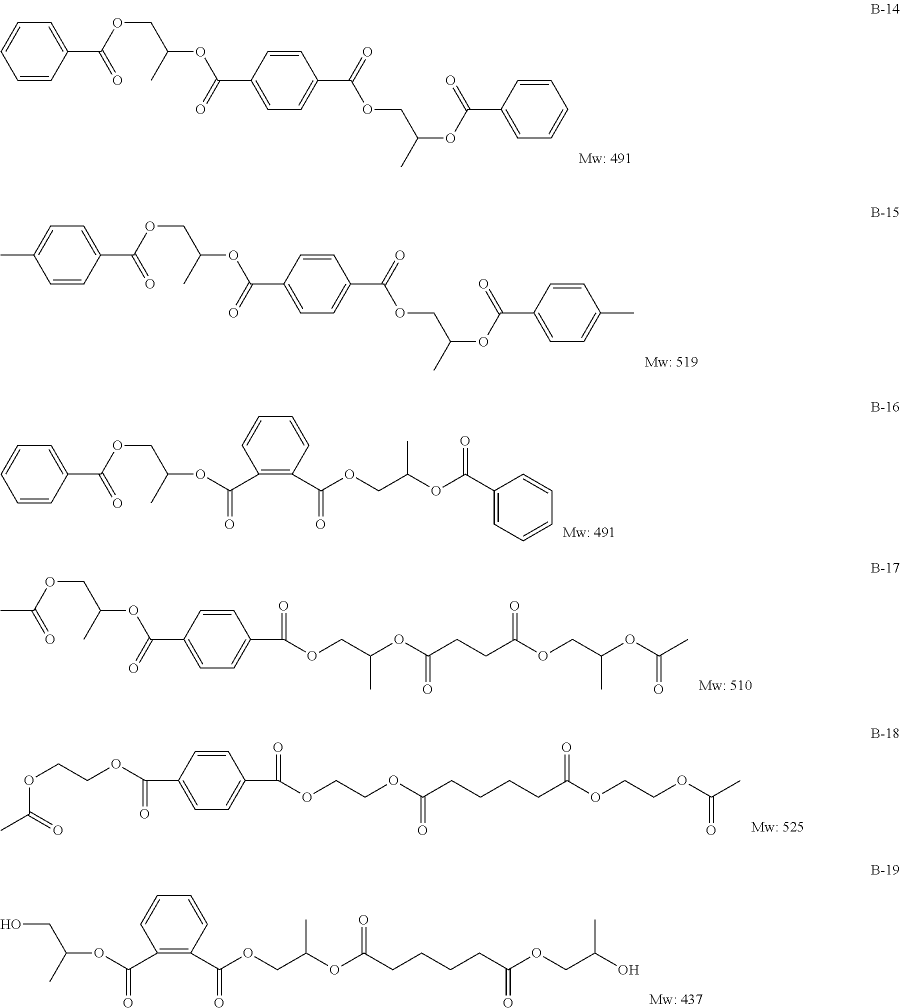

When the ester-base compound is contained in the optical film of this invention, the content thereof, relative to the mass of cellulose acylate, is preferably 0.1 to 30% by mass, and more preferably 0.5 to 10% by mass.

In this invention, it is also preferable to use, as the additive, the monocyclic compound represented by Formula (1) or Formula (2), in combination with a plasticizer (sugar ester compound, ester-base compound, etc. described above). For the case where the monocyclic compound and the plasticizer are used in combination, the ratio of use is not specifically limited, where it is preferable to add 1.5 to 15 parts by mass of plasticizer relative to 1 part by mass of the monocyclic compound, and more preferable to add 2 to 8 parts by mass of plasticizer.

### <Method of Manufacturing Optical Film>

The method of manufacturing an optical film of this invention may be, for example, solvent casting or melt casting, and preferably solvent casting, but not specifically limited.

The solvent casting may be implemented by a step of preparing a dope by dissolving the cellulose acylate and additives into a solvent; a step of casting the dope onto a loop-running endless metal support; a step of drying the cast dope to obtain a web; a step of peeling off the web from the metal support; a step of stretching the web or retaining the width; a step of further drying the web; and a step of taking up a resultant film.

The step of preparing the dope will be described. The higher the concentration of cellulose acylate in the dope, the more the load of drying after cast on the metal support will be reduced, whereas an excessively high concentration of the cellulose acylate will increase the load of filtration to worsen the accuracy of filtration. The concentration for successfully balancing both of them is preferably 10 to 35% by mass, and more preferably 15 to 25% by mass.

Solvent used for the dope is preferably a mixed solvent of two or more species, which are good solvent and poor solvent for cellulose acylate, from the viewpoint of productivity, wherein a larger amount of good solvent is preferable from the viewpoint of solubility of the cellulose acylate.

Preferable ratios of mixing of the good solvent and the poor solvent fall in the range from 70 to 98% by mass for the good solvent, and 2 to 30% by mass for the poor solvent. As for definition of the good solvent and the poor solvent, those capable of dissolving the cellulose acylate to be used solely by themselves are referred to as good solvent, and those incapable of swelling or dissolving it solely by themselves are referred to as poor solvent. Accordingly, the good solvent and the poor solvent may be switched depending on the degree of substitution of acyl group of the cellulose acylate.

The good solvent used in this invention is exemplified by organohalogen compound such as methylene chloride, dioxolanes, acetone, methyl acetate and methyl acetoacetate, without special limitation. Methylene chloride and methyl acetate are particularly preferable.

The poor solvent used in this invention, for the dope for solvent casting of the optical film (also referred to as cellulose acylate solution, hereinafter), is preferably exemplified by methanol, ethanol, n-butanol, cyclohexane, and cyclohexanone, without special limitation.

The poor solvent used for the cellulose acylate solution is preferably alcohols having an average number of carbon atoms of 4 or less from the viewpoint of solubility, and preferably alcohols having an average number of carbon atoms of 2 to 4 from the viewpoint of peeling load.

As for preferable range of mixing of the good solvent and the poor solvent used for the cellulose acylate solution, the content of alcohol is preferably suppressed to 30% by mass or less from the viewpoint of solubility of the cellulose acylate, meanwhile the content of alcohol as the poor solvent is preferably 15% by mass or more from the viewpoint of relieving the peeling load. The solvent of the dope used for solution casting of the optical film preferably contains 15 to 30% by mass of alcohol.

When the dope is prepared, the cellulose acylate may be dissolved by any general method. Combination of heating and pressurizing enables heating at and above the boiling point at normal pressure.

Dissolution under stirring of the dope, while heated at a temperature higher than the boiling point of the solvent at normal pressure but capable of avoiding boiling of the solvent under pressure, is advantageous in view of preventing formation of insoluble clot called gel or lump.

Another preferable method of dissolution is such as mixing the cellulose acylate with the poor solvent so as to moisten or swell it, followed by addition of the good solvent for dissolution.

The pressurizing may be effected by introducing an inert gas such as nitrogen gas under compression, or by elevating the vapor pressure of the solvent under heating. The heating is preferably given externally. A jacket-type heater is preferable in view of simplicity of temperature control.

While the higher the heating temperature after addition of the solvent, the more preferable in terms of solubility of the cellulose acylate, an excessively high heating temperature will need additional pressure to degrade the productivity.

The heating temperature is preferably 45 to 120° C., more preferably 60 to 110° C., and furthermore preferably 70° C. to 105° C. The pressure is controlled so as not to allow the solvent to boil at the preset temperature.

Alternatively, cold dissolution process is preferably used, by which the cellulose acylate may be dissolved into solvent such as methyl acetate.

Next, the cellulose acylate solution is filtered through an appropriate filter material such as filter paper. While the filtering material preferably has a small absolute filter rating for the purpose of removing insoluble matters, a too small a absolute filter rating may unfortunately cause clogging of the filter material.

The filter material, therefore, preferably has an absolute filter rating of 0.008 mm or less, more preferably 0.001 to 0.008 mm, and furthermore preferably 0.003 to 0.006 mm.

Materials for composing the filter material may be any general material without special limitation, wherein plastic filter materials such as polypropylene and Teflon (registered trademark), and metal filter materials such as stainless steel are preferable, since they are unlikely to drop fiber. By such filtration, it is preferable to remove or reduce a contaminant, in particular bright dot contaminant, having been contained in the source cellulose acylate.

The bright dot contaminant is observable as leakage of light coming from the opposite side in the form of bright dots, when the optical film is placed between a pair of polarizing plates arranged in a crossed-nicol state, light is made incident on one polarizing plate, and the laminate is observed on the side of the other polarizing plate. The number of bright dots of 0.01 mm or larger in diameter is preferably 200 dots/cm² or less.

The number is more preferably 100 dots/cm² or less, more preferably 50 dots/cm² or less, and furthermore preferably 0 to 10 dots/cm² or less. Also the number of bright dots less than 0.01 mm in diameter is preferably small.

The dope may be filtered by any general method, wherein it is preferable to filter the dope, while heating it to a temperature not lower than the boiling point of the solvent but not allowing the solvent to boil under pressure, in view of reducing difference in filtration pressure before and after filtration (referred to as differential pressure).

The temperature is preferably 45 to 120° C., more preferably 45 to 70° C., and furthermore preferably 45 to 55° C.

The smaller the filtration pressure, the better. The filtration pressure is preferably 1.6 MPa or below, more preferably 1.2 MPa or below, and furthermore preferably 1.0 MPa or below.

Next, casting of the dope will be explained.

The metal support used for casting preferably has a mirror-finished surface, wherein a stainless steel belt or a molded drum with a plated surface are preferably used as the metal support.

The width of casting may be 1 to 4 m. The temperature of the surface of the metal support in the step of casting preferably falls in the range from −50° C. up to a temperature below the boiling point of the solvent. While the higher the temperature, the faster the web dries, an excessively high temperature may unfortunately foam the web, or may degrade the planarity.

The temperature of the support is preferably 0 to 55° C., and more preferably 25 to 50° C. Another preferable method is such as gelating the web by cooling, and peeling the web, with a lot of residual solvent retained therein, from the drum.

While method of controlling the temperature of the metal support is not specifically limited, possible methods include blowing of hot air or cold air, and contact of warm water with the back side of metal support. The method of using warm water is more preferable, since the heat conduction is more efficient, and can therefore shorten the time before the temperature of metal support reaches constant. When hot air is used, a hot air at a temperature higher than a target temperature may occasionally be used.

For a good planarity of the optical film, the amount of residual solvent when the web is peeled off from the metal support is preferably 10 to 150% by mass, more preferably 20 to 40% by mass or 60 to 130% by mass, and particularly 20 to 30% by mass or 70 to 120% by mass.

In this invention, the amount of residual solvent is defined by the formula below:

Amount of residual solvent (% by mass)={(M−N)/N}×100

where, M represents the mass of a sample collected at an arbitrary point of time during manufacture or drying of the web or the film, and N represents the mass of the film after heated at 115° C. for one hour.

In the step of drying the optical film, the web is preferably peeled off from the metal support, and further dried to reduce the amount of residual solvent down to 1% by mass or less, more preferably 0.1% by mass or less, and particularly 0 to 0.01% by mass or less.

In the step of drying the film, generally used is a roll drying system (a system allowing the web to meander through a number of rolls vertically arranged), or a tenter system, where the web is dried while it is fed.

For the manufacture of the optical film, it is particularly preferable to stretch the web in the widthwise direction (transversely) by the tenter system by which both sides of the web are held by clips or the like. The peeling is preferably effected under a separating tension of 300 N/m or below.

The web may be dried generally with hot air, infrared radiation, heating roll or microwave without special limitation, and preferably with hot air in view of simplicity.

The drying temperature in the step of drying the web is preferably elevated stepwisely from 40 to 200° C.

In order to impart retardation Re and Rth to the optical film, it is preferable to further control the refractive index anisotropy, by controlling feeding tension and stretching.

For example, the retardation value is variable by decreasing or increasing the tension in the longitudinal direction.

The optical film of the present invention can be biaxially stretched.

When biaxial stretching is carried out, it is preferred that the film is stretched in MD direction (feed direction), and then is stretched in TD direction (which is orthogonal to feed direction, and is referred to as longitudinal direction). When the film is stretched, the film may contain a residual solvent, or the film which does not contain a residual solvent may be stretched. When the film contains a residual solvent, it is preferred that the film is stretched in a state where the solvent amount is 0.1% by weight to 50% by weight to the film solid weight.

The factor of stretching in MD direction of the film is preferably 0 to 70%, and is more preferably 0 to 60%, and is particularly preferably 0 to 50%. The aforementioned factor of stretching can be achieved by making the differences of the film feed speed at the inlet of the stretching zone and the film feed speed at the outlet of the stretching zone. For example, when a device having two nip rolls is used, a cellulose acylate film can be preferably stretched in MD direction by making the rotation speed of nip roll at the out let faster than the rotation speed of nip roll at the inlet of the stretching zone. The factor of stretching (%) used herein is defined by the following formula.

The factor of stretching (%)=100×[(length after stretching)−(length before stretching)]/length before stretching

The factor of stretching in the stretching in the film TD direction is preferably larger than 20%, and is more preferably larger than 20% and 60% or less, and is particularly preferably 22 to 55%, and is further particularly preferably 23 to 50%.

The film surface temperature at the time of initiation of stretching is preferably 100° C. to 220° C., and is more preferably 120° C. to 200° C.

In the present invention, it is preferred to carry out stretching by using a tenter device as a method for stretching a film in TD direction.

Desired Re and Rth can be achieved by controlling the factor of stretching in MD direction, the residual solvent amount at the time of stretching, the stretching temperature, the factor of stretching in TD direction, the residual solvent amount at the time of stretching, and the stretching temperature.

Methods of stretching the web are not specifically limited. Exemplary methods include a method of longitudinally stretching the film over a plurality of rolls which rotate at different peripheral speeds, making use of the difference in speed; a method of longitudinally stretching the web, by holding the web at both sides thereof with clips of pins, and by expanding the distance between the clips or pins in the feeding direction; a method of transversely stretching the web in a similar manner but by expansion in the transverse direction; and a method of stretching the web bidirectionally, so as to be widened concomitantly in the longitudinal direction and in the transverse direction. Of course, these methods may be used in combination.

In the so-called tenter process, it is preferable to drive the clip portions based on the linear drive system, in view of enabling smooth stretching and reducing a risk of breakage of the film.

Such width-retention or transverse stretching in the manufacturing process is preferably given by a tenter, which may be either a pin tenter or a clip tenter.

Assuming now that the slow axis and fast axis of the optical film lie in plane, and that the angle to the machine direction as θ1, such θ1 is preferably −1° or larger and +1° or smaller, more preferably −0.5° or larger and +0.5° or smaller, furthermore preferably −0.3° or larger and +0.3° or smaller, and most preferably −0.1° or larger and +0.1° or smaller.

The θ1 may be defined by the angle of orientation, and may be measured using an automatic birefringence analyzer KOBRA-21ADH (from Oji Scientific Instruments). The above-described relations regarding θ1, when satisfied, contributes to obtain a high luminance of displayed image, to suppress or prevent leakage of light, and also to obtain true color reproduction on the liquid crystal display device.

### [Hot Steam Treatment]

The stretched film may be processed subsequently by a step of spraying thereon a hot steam heated at 100° C. or above. The step of spraying steam advantageously relaxes residual stress in the resultant optical film, and reduces dimensional changes. While the temperature of steam is not specifically limited so long as it is 100° C. or above, it may practically be 200° C. or lower taking heat resistance of the film and so forth into account.

A range of processes from casting up to post-drying may proceed under an air atmosphere or under an inert gas atmosphere typically containing nitrogen. A winder used for manufacturing the optical film may be any of those generally used, so that the film may be wound up by any of winding methods including constant-tension method, constant-torque method, tapered tension method, and programmed tension control method with a preset constant internal stress.

The thus obtained optical film is preferably wound up to produce a 100 to 10000-m roll, more preferably a 500 to 7000-m roll, and furthermore preferably a 1000 to 6000-m roll. In the process of winding, the film is preferably knurled at least on one side, with a width of knurling of preferably 3 mm to 50 mm, and more preferably 5 mm to 30 mm; and with a height of knurling of preferably 0.5 to 500 μm, and more preferably 1 to 200 μm. The knurling may be either single-sided or double-sided.

Since degradation in contrast and change in hue in oblique view become remarkable generally in large-screen display device, so that the polarizing plate of this invention, manufactured using the optical film, is particularly suitable for use in the large-screen liquid crystal display device. When used for the large-screen liquid crystal display device, the optical film is preferably formed into a film of 1470 mm wide or wider. Embodiments of the optical film include not only a cut film suitably sized for incorporation into the liquid crystal display device, but also a continuously-produced long web wound up in a roll. The optical film according to the latter embodiment is stored and transported as it is, and is cut for use when it is actually incorporated into the liquid crystal display device, or laminated with a polarizer or the like. Alternatively, the optical film in the form of long web may be laminated typically with the polarizer configured by a polyvinyl alcohol film or the like, again in the form of long web, and is cut when it is actually incorporated into the liquid crystal display device. One possible embodiment of the rolled cellulose acylate film is a 2500-m roll or a longer roll.

### (Polarizing Plate)

The polarizing plate of this invention has at least the optical film of this invention described above, and a polarizer. The polarizing plate of this invention is preferably configured so that the polarizer is held between the optical film of this invention and an outer film. It is particularly preferable that the outer film shows a moisture permeability of 100 g/m² or less, after allowed to stand in a 40° C./90% relative humidity environment for 24 hours.

Thinned optical film may otherwise be anticipated for non-uniform dewing. The non-uniform dewing means non-uniformity of wetting with water which partially, in general, adheres to the film, producing a wetted area and an unwetted area. In this invention, such non-uniform dewing is advantageously suppressed by using, as the outer film, a film which shows a moisture permeability of 100 g/m² or below, after allowed to stand in 40° C./90% relative humidity environment for 24 hours. The moisture permeability measured after allowed to stand in 40° C./90% relative humidity environment for 24 hours is more preferably 90 g/m² or below, and furthermore preferably 80 g/m² or below. The moisture permeability observed after allowed to stand in 40° C./90% relative humidity environment for 24 hours may be determined, for example, by measuring moisture permeability of the film according to JIS Z-0208, and then converting it into the amount of vaporized water (g) over 24 hours per 1-m² area.

The outer film, either satisfying or not satisfying a moisture permeability of 100 g/m² or below, is exemplified by polyester-base polymer such as polyethylene terephthalate and polyethylene naphthalate; cellulose-base polymers such as diacetyl cellulose and triacetyl cellulose; acrylate-base polymers such as polymethyl methacrylate; and polycarbonate-base polymer; without special limitation. Among the polymer films configured by the polymers exemplified above, cellulose-base polymer film and acrylate-base polymer film are preferable as the protective film for the polarizer, and cellulose-base polymer film, and in particular cellulose acylate film is preferable.

The outer film may be a laminated film which contains two or more layers of cellulose acylate film having different compositions. In this case, the degree of acyl substitution, species and amount of additives contained in the film, of the individual cellulose acylate films composing the laminated film may be arbitrarily selectable depending on target physical properties of the film.

The outer film may be manufactured by any known method such as solvent casting. The outer film may contain additive(s) optionally selected depending on needs. Details of the additives may be referred, for example, to paragraphs [0040] to [0126] of JP-A-2012-225994.

The outer film, when configured as double or more layered laminated film, preferably has a double-layered structure or three-layered structure. For the three or more layered laminated structures, the inner layer of the film is called core layer. The three-layered film preferably has a top layer (referred to as “support-faced layer”, hereinafter) which is brought into contact with the support when the outer film is manufactured by solvent casting, another top layer opposite to the side brought into contact with the support (referred to as “air-faced layer”, hereinafter), and a single core layer thicker than these top layers. Meanwhile, the film having a double-layered structure contains a top layer which is brought into contact with the support when the outer film is manufactured by solvent casting (also referred to as “support-faced layer”, hereinafter), and another layer (also referred to as “core layer”, hereinafter).

When the outer film is configured by a cellulose acylate film, the core layer preferably has a thickness of 78 μm or thinner, more preferably in the range from 13 to 68 and furthermore preferably in the range from 18 to 62 μm. The support-faced layer preferably has a thickness of 10 μm or thinner, and typically in the range from 1 to 10 Preferable ranges of the thickness of the air-faced layer in the three-layered film are same as the preferable ranges for the support-faced layer.

The outer film disposed on a side of the polarizer which is opposite to a liquid crystal cell, is mainly serves as a protective film, with the thickness not specifically limited.

The outer film preferably has a thickness in the range from 700 to 3000 mm, more preferably from 1000 to 2800 mm, and furthermore preferably from 1300 to 2500 mm.

As the outer film, preferably usable are commercially-available cellulose triacetate film (Fujitac TD60, from FUJIFILM Corporation), an alicyclic structure-containing polymer resin film described in JP-A-2006-58322, an acrylic resin described in JP-A-2009-122644, and Cosmoshine SRF (from Toyobo Co., Ltd.).

### <Polarizer>

In this invention, any general linear polarizer may be used as the polarizer. The polarizer may be composed of a stretched film, or may be a layer formed by coating. The former is exemplified by a stretched polyvinyl alcohol film dyed with iodine, dichroic dye or the like. The latter is exemplified by a layer formed by coating a composition containing a dichroic liquid-crystalline dye, and by fixing the dye in an aligned manner.

Now, in this specification, “polarizer” means linear polarizer. In the polarizing plate of this invention, the polarizer is preferably 3 to 30 μm thick, and more preferably 5 to 25 μm thick.

The thickness of the polarizer is not particularly limited, but is preferably 5 to 15 μm in view of suppressing wavy curl of the polarizing plate.

### <Active Energy Curable Adhesive>

In this invention, the outer film and the polarizer are preferably bonded using an active energy curable adhesive. Light is generally used as an active energy ray. The light is exemplified by microwave, infrared radiation, visible light, ultraviolet radiation, X-ray, and γ-ray, although not specifically limited.

Between the polarizer and the outer film, formed is an active energy curable adhesive layer composed of an active energy curable adhesive. The adhesive layer is preferably 0.01 to 5 μm thick, and is more preferably 0.2 to 3 μm thick. A good adherence will be obtained by controlling the thickness to 0.01 μm or larger, and the panel is effectively prevented from warping by controlling the thickness to 5 μm or thinner.

The active energy curable adhesive is an adhesive which cures upon being irradiated with active energy ray, and contains no solvent (solvent-free).

Now “solvent-free” means that the adhesive, when coated onto an article to be adhered, contains no solvent at all, or contains only less than 2% by mass of solvent, relative to the total mass of adhesive. The content of solvent in the adhesive may be measured typically by gas chromatography.

As the active energy curable adhesive, those described in paragraphs [0015] to [0031] of JP-A-2008-40278 are usable. Active energy ray curable compound, which composes a major ingredient of the active energy ray curable, solvent-free adhesive, is exemplified by those curable by radical polymerization induced by active energy ray (photo-radical polymerizable compound), such as compound having acryloyl group, methacryloyl group, allyl group or other functional group; and those curable by photo-cationic reaction induced by active energy ray (photo-cationic polymerizable compound), such as compound having epoxy group, oxetane group, hydroxy group, vinyl ether group, episulfide group, ethyleneimine group or other functional group.

As the photo-radical polymerizable compound, those described in paragraph [0018] of JP-A-2008-40278, and those described in paragraph [0019] of JP-A-2008-40278 may be used. These compounds may be used independently, or two or more species may be used in the form of mixture.

The active energy ray curable adhesive may be mixed with a polymerization initiator, for the purpose of enhancing efficiency of curing reaction of the active energy ray curable adhesive. As the polymerization initiator, usable are photo-radical polymerization initiators of acetophenone-base, benzophenone-base, thioxanthone-base, benzoin-base and benzoin alkyl ether-base; and photo-cationic polymerization initiators such as aromatic diazonium salt, aromatic sulfonium salt, aromatic iodonium salt, metallocene compound, and benzoin sulfonate ester, all of which are described in paragraphs [0021] to [0027] of JP-A-2008-40278. Amount of mixing of the polymerization initiator is generally 0.5 to 10 parts by mass, per 100 parts by mass of the active energy ray curable compound.

The active energy ray curable adhesive may further be mixed with photo-sensitizer, antistatic agent, infrared absorber, ultraviolet absorber, antioxidant, organic particle, inorganic oxide particle, pigment, dye and so forth. By using the photo-sensitizer, the reactivity may be improved, and thereby mechanical strength and adhesion strength of the cured adhesive may be improved. The photo-sensitizer is exemplified by carbonyl compound, organic sulfur compound, persulfate, redox compound, azo compound, diazo compound, halogen compound, and photo-reductive colorant, but not specifically limited thereto. Specific examples of the photo-sensitizer usable here may be those described in paragraph [0031] of JP-A-2008-40278. Content of the photo-sensitizer preferably falls in the range from 0.1 to 20 parts by mass, per 100 parts by mass of the active energy ray curable compound.

### <Method of Manufacturing Polarizing Plate>

The polarizing plate of this invention may be manufactured by bonding the outer film on one surface of the polarizer, and by bonding the optical film of this invention on the other surface of the polarizer. The outer film may be bonded to one surface of the polarizer, preferably by using the active energy curable adhesive. While a means for bonding the optical film of this invention to the other surface of the polarizer is not specifically limited, the above-described active energy curable adhesive may be used.

When the outer film and/or the optical film of this invention are bonded using the active energy ray curable adhesive, the active energy ray is irradiated to cure the adhesive, to thereby fix the outer film and/or the optical film of this invention onto the polarizer. Possible methods of coating the adhesive onto the polarizer include those using doctor blade, wire bar, die coater, comma coater, and gravure coater, any of them may be used without special limitation.

In advance of bonding the outer film and the optical film to the polarizer, the bonding surface may be subjected to easy-adhesion treatment such as saponification, corona treatment, primer treatment, or anchor coating.

In this invention, light is generally used as the active energy ray. The light is exemplified by microwave, infrared radiation, visible light, ultraviolet radiation, X-ray, and γ-ray, without special limitation. In particular, ultraviolet radiation is preferably used, since a relatively large energy is obtainable with simple handling.

Light source used for irradiating ultraviolet radiation is exemplified by low pressure mercury lamp, middle pressure mercury lamp, high pressure mercury lamp, extra-high pressure mercury lamp, chemical lamp, black light lamp, microwave-excited mercury lamp and metal halide lamp, but not specifically limited thereto. While the radiation intensity is not specifically limited, it is preferably 0.1 to 100 mW/cm² in a wavelength region where the polymerization initiator may be activated effectively. If the radiation intensity is less than 0.1 mW/cm², the reaction time may elongate excessively, meanwhile if exceeding 100 mW/cm², the adhesive may turn into yellow, or the polarizer per se may degrade, due to radiation heat from the lamp, heat of polymerization reaction, and so forth. While irradiation time may suitably be selected depending on state of curing without special limitation, it is preferably set so that the cumulative radiation, given by the product of radiation intensity and irradiation time, falls in the range from 10 to 5,000 mJ/cm².

Embodiments of the polarizing plate of this invention include not only a cut film suitably sized for incorporation directly into the liquid crystal display device, but also a continuously-produced long web wound up in a roll (for example, 2500 m or longer roll, or 3900 m or longer roll). For use in the large-screen liquid crystal display device, the polarizing plate is preferably 1470 mm wide or wider, as described previously.

### <Widthwise Variation of Polarizing Plate (Axial Deviation)>

Widthwise variation of the polarizing plate of this invention preferably falls in the range described below. More specifically, when the polarizing plate is unwound 10 meters, and every five pieces is sampled at 2-meter intervals in the longitudinal direction, and at regular intervals in the widthwise direction, the axial deviation given by Formula (A) below preferably shows a maximum value of 0.4° or less, and more preferably 0.3° or less.

(Axial Deviation)=|(Angle between slow axis of optical film and absorption axis of polarizer)−90°| Formula (A):

### (Wavy Curl)

The wavy curl means a phenomenon where a polarizing plate obtained by laminating a protect film, a protective film, a polarizer, a optical film, an adherent, and a separate film in this order is deformed to be wave-like shape due to wet expansion of the edge of the polarizing plate as a result that the edge of the polarizing plate adsorbs water when placed under an environment of high humidity.

It was revealed that the wavy curl of the polarizing plate can be suppressed when the thickness of the polarizer is 5 to 15 μm and a biaxially stretched optical film is used. Although its mechanism has not been revealed, it is assumed that the expansion is suppressed when the thickness of the polarizer is 5 to 15 μm, and the optical film functions to suppress the expansion of polarizer when a biaxially stretched optical film is used.

### (Liquid Crystal Display Device)

The invention also relates to a liquid crystal display device having the optical film of this invention or the polarizing plate of this invention.

The liquid crystal display device of this invention is preferably an IPS-, OCB- or VA-mode liquid crystal display device having a liquid crystal cell, and a pair of polarizing plates arranged on both sides the liquid crystal cell, wherein at least one of the polarizing plates is the polarizing plate of this invention. The optical film of this invention is preferably disposed on the side of liquid crystal cell, or, between the liquid crystal cell and the polarizer.

There is no special limitation on specific configuration of the liquid crystal display device of this invention, allowing adoption of any known configurations. For example, a configuration illustrated in FIG. 2 of JP-A-2008-262161 is adoptable.

### EXAMPLE

Features of this invention will further be detailed referring to Examples and Comparative Examples. Materials, amounts of consumption, ratios, details of processes, and procedures of processes described in Examples below may be modified suitably, without departing from the spirit of this invention. The scope of this invention is therefore by no means interpreted limitatively by Examples described below.

### (Synthesis of Compound 1-a)

Compound 1-a was synthesized according to a method described in J. Chem. Soc., Perkin Trans. 1, 1997, 3189-3196. Specific procedures are as follows. A mixture of dibenzoylethane (100 kg), ammonium acetate (200 kg), and acetic acid (1 m³) was refluxed for 20 hours. After cooled, the reaction mixture was poured into cold water (10 m³), a solid was collected by filtration, washed with water, and dried to obtain compound 1-a as a thin needle-like product (90 kg, 98%) (m.p.=142 to 143° C.).

Compound 1-b was synthesized in the same way as Compound 1-a.

Compound 1-d was synthesized according to a method described in European patent (EP) No. 0389904 A2.

Compound 3-a was synthesized referring to a synthetic method described in J Am. Chem. Soc., 2003, 125, 10580-10585. Specific procedures are as follows. 2-Phenylimidazole (50 kg) and MgO (16.8 kg, 1.2 equivalent equivalent) were suspended in 1 m³ of anhydrous dioxane, and vigorously stirred at room temperature for 10 minutes to obtain a homogeneous suspension. Pd(OAc)₂ (3.9 kg, 5 mol %) and PPh₃ (18.2 kg, 0.2 equivalent) were added to the mixture in an argon atmosphere under vigorous stirring. Iodobenzene (84.9 kg, 1.2 equivalent) was dissolved in 0.5 m³ of anhydrous dioxane, and added dropwise to the solution obtained above, and the reaction mixture was heated in an argon atmosphere up to 150° C. The solvent was distilled off, and the residue was subjected to flash column chromatography (elution gradient: hexane- ->20% ethyl acetate/80% hexane) in several batches, to thereby isolate compound 3-a (62 kg, yield=82%).

Compound 6-a was synthesized according to a synthetic method described in Bioorganic & Medicinal Chemistry, 2010, 18, 6184-6196, as below. In a N₂ atmosphere, a mixture of benzoic acid hydrazide (40 kg, 293 mol, 1 equivalent) and benzonitrile (396 kg, 3840 mol, 13.1 equivalent) was stirred at the reflux temperature for 14 hours. The mixture was cooled down to room temperature, the obtained precipitate was collected by filtration, and washed with 2-propanol. Re-crystallization from 2-propanol yielded a white solid of compound 6-a (37.7 kg, 58%). ¹H NMR (400 MHz, DMSO-d6): δ 7.41-7.59 (m, 6H), 8.07-8.10 (m, 211), 8.12 (1s, 1H); 13C NMR (100 MHz, DMSO-d6): δ 125.9, 126.1, 128.7, 129.1, 130.2, 131.3; HRMS (EI) [M]+ Calcd for C14H11N3: 221.0953. Found: 221.0948.

Also compound 6-b was synthesized according to the synthetic methods of compound 6-a.

Compound 7-a and compound 8-a were synthesized by a known esterification reaction and amidation reaction, from commercially-available 1H-pyrrole-2,5-dicarboxylic acid.

Compound 5-b was synthesized as follows. Acetophenone (80 g, 0.67 mol) and dimethyl isophthalate (52 g, 0.27 mol) were added to anhydrous tetrahydrofuran (520 ml), and then sodium amide (52.3 g, 1.34 mol) was slowly added dropwise to the mixture under a nitrogen atmosphere while the mixture is stirred under ice cooling. After the mixture was stirred under ice cooling for 3 hours, the mixture was stirred under water cooling for 12 hours. Sulfuric acid was added to the reaction solution for neutralization, and then pure water and ethyl acetate were added thereto for liquid separation. The organic layer was washed with pure water. The organic layer was dried over magnesium sulfate, and a solvate was distilled away under reduced pressure. To the resultant crude crystalline was added methanol for suspension washing. Thus, an intermediate A (55.2 g) was obtained. The intermediate (55 g, 0.15 mol) was added to tetrahydrofuran (300 ml) and ethanol (200 ml). While the mixture is stirred at room temperature, hydrazine monohydrate (18.6 g, 0.37 mol) was slowly added dropwise. After completion of the addition, the obtained mixture was heat-refluxed for 12 hours. Pure water and ethyl acetate were added to the reaction solution for liquid separation. The organic layer was washed with pure water. The organic layer was dried over magnesium sulfate, and a solvate was distilled away under reduced pressure. The resultant crude crystalline was purified by a silica gel column chromatography (ethyl acetate/heptane) to obtain Compound 5-b (27 g). 1H-NMR spectrum of the obtained compound 5-b is as follows. Measurement was carried out by adding a few drops of trifluoroacetic acid in the measurement solvent in order to avoid complex chemical shift due to tautomer.

1H-NMR (400 MHz, solvent: deuterated DMSO, standard: tetramethylsilane) δ (ppm): 8.34 (1H, s), 7.87-7.81 (6H, m), 7.55-7.51 (1H, m), 7.48-7.44 (4H, m), 7.36-7.33 (2H, m), 7.29 (1H, s)

### (Manufacture of Optical Film 1)

<Exemplary Manufacture of Cellulose Acetate with Degree of Substitution of 2.4>

### [See Comparative Example 1 of JP-A-2011-215630]

A hardwood prehydrolysis-kraft pulp having an α-cellulose content of 98.4% by mass was processed using a disk refiner into flocculent cellulose. One hundred parts by mass of flocculent cellulose (moisture content=8.0% by mass) was sprayed with 26.8 parts by mass of acetic acid, mixed thoroughly, and allowed to stand still for 60 hours for pretreatment (first activation step). The activated pulp was added to a mixture composed of 323 parts by mass of acetic acid, 245 parts by mass of acetic anhydride, and 13.1 parts by mass of sulfuric acid, the mixture was heated from 5° C. up to a maximum temperature of 40° C. over 40 minutes, and allowed to acetylate for 110 minutes. A neutralizing agent (24% by mass aqueous magnesium acetate solution) was added thereto over 3 minutes, so as to adjust the content of sulfuric acid (amount of sulfuric acid for ripening) to 2.5 parts by mass. The reaction bath was then heated to 75° C., to which water was added to adjust the water concentration in the reaction bath (amount of water for ripening) to 44 mol %. Now, the water concentration for ripening is represented by the molar ratio of water in the reaction bath relative to acetic acid, which was multiplied by 100 to give it in mol %. Ripening was then allowed to proceed at 85° C. for 100 minutes, then terminated by neutralizing sulfuric acid with magnesium acetate, to thereby obtain a reaction mixture containing cellulose diacetate. The thus obtained reaction mixture was added with a dilute aqueous acetic acid solution to isolate cellulose diacetate, followed by washing with water, drying, and stabilization with calcium hydroxide, to thereby obtain cellulose diacetate having a degree of substitution of 2.4 (6% by mass, and a viscosity of 60 mPa·s).

### <Particle Dispersion>

| | |
|---|---|
| Particle (Aerosil R812, from Nippon Aerosil Co., Ltd.) | 11 parts by mass |
| Ethanol | 89 parts by mass |

The ingredients above were mixed under stirring for 50 minutes using a dissolver, and then dispersed using a Manton-Gaulin homogenizer.

### <Particle Addition Liquid>

| | |
|---|---|
| Methylene chloride | 99 parts by mass |
| Cellulose acetate with degree of substitution of 2.4 | 4 parts by mass |
| Particle dispersion | 11 parts by mass |

Into a dissolution tank containing methylene chloride, added was cellulose acetate having a degree of substitution of 2.4, the content was heated for complete dissolution, and the solution was then filtered through Azumi Filter Paper No. 244 from Azumi Filter Paper Co., Ltd. While keeping the filtered cellulose acetate solution vigorously stirred, the particle dispersion was added slowly, and the mixture was then dispersed using an attritor. The dispersion was filtered through Finemet NF from Nippon Seisen Co., Ltd., to thereby prepare a particle addition liquid.

### <Main Dope>

Using cellulose acetate having a degree of substitution of 2.4, a main dope was prepared according to the composition below.

### <Composition of Main Dope>

| | |
|---|---|
| Methylene chloride: | 390 parts by mass |
| Ethanol: | 80 parts by mass |
| Cellulose acetate having degree of substitution of 2.4 | 100 parts by mass |
| Monocyclic compound 1-a represented by Formula (2) | 2.5 parts by mass |
| Sugar ester compound A-5: | 13 parts by mass |

First, methylene chloride and ethanol were placed in a pressurized dissolution tank. To the pressurized dissolution tank containing the solvent, cellulose acetate was added under stirring. The content was heated, completely dissolved under stirring, to which 2.5% by mass, relative to cellulose acetate, of monocyclic compound 1-a represented by Formula (2), and 13% by mass of sugar ester compound A-5 as a plasticizer were added and dissolved. The mixture was filtered through Azumi Filter Paper No. 244 from Azumi Filter Paper Co., Ltd., to thereby prepare the main dope.

To 100 parts by mass of the main dope, 2 parts by mass of the particle addition liquid was added, the mixture was thoroughly mixed using an in-line mixer (static in-pipe mixer Hi-Mixer, SWJ, from Toray Engineering Co., Ltd.), and then uniformly cast over a stainless steel band support of 2 m wide using a belt casting apparatus.

The obtained web (film) was allowed to stand so as to vaporize the solvent until the content of residual solvent falls down to 110% by mass, and then peeled off from the stainless steel band. The peeled film was tensioned so as to longitudinally stretch it by a factor of stretching of 2%.

The film was then dried until the content of residual solvent falls below 1% by mass, and further stretched at 165° C. by 35% using a tenter, in the direction perpendicular to the film feed direction.

The content of residual solvent was determined by the equation below:

Content of residual solvent (% by mass)={(M−N)/N}×100

where, M represents mass of the web at an arbitrary point of time, and N represents mass of the web, for which M was measured, after dried at 120° C. for 2 hours.

In this way, an optical film 1 (also simply referred to as film 1, hereinafter) of 1.5 m wide and 35 μm thick, with a knurling of 1 cm wide and 8 μm high formed on the sides thereof, was manufactured.

### (Manufacture of Optical Films 2 to 20)

Films 2 to 20 were manufactured in the same way as the film 1, except that the degree of substitution of cellulose acylate, additives, stretching temperature and thickness were altered. Compound N1 used for film 18 was shown below.

Compound N1: Me represents a methyl group.

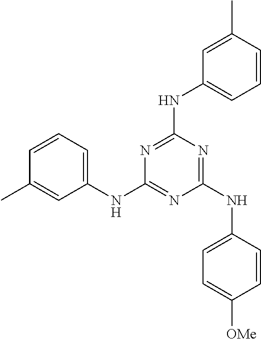 [SMILES: COc1ccc(Nc2nc(Nc3cccc(C)c3)nc(Nc3cccc(C)c3)n2)cc1]

### (Manufacture of Optical Films 21 and 22)

A cellulose acetate propionate having substitution degree of 2.5 (acetyl substitution degree: 1.6, and propionyl substitution degree: 0.9) was synthesized with reference to the method of JP-A-10-45804. Optical films 21 and 22 were manufactured in the same way as in Example 1, except for the type of cellulose acylate, additives, stretching temperature and film thickness.

### (Manufacture of Optical Films 23, 24 and 25)

Optical films 23, 24 and 25 were manufactured in the same way as the method for production of Films 3, 21 and 22, except that the factor of longitudinal stretching was 7% by making the speed different as to the metal support speed and the stripping speed (stripping roll draw), and that the factor of TD stretching was changed as shown in Table 2.

The manufactured optical films have a slow axis which is parallel to the TD direction.

### (Evaluation)

The thus obtained films 1 to 25 were evaluated as follows.

### <Retardation>

Re(450), Re(630) and Rth(550) were measured using AxoScan (from Axometrics, Inc.) in a 23° C./55% relative humidity environment at 450 nm, 550 nm and 630 nm, respectively. These values were calculated by extrapolation of retardation values obtained by perpendicular measurement and retardation values obtained in the same way while inclining the film plane.

Rth(30%) was measured using AxoScan (from Axometrics, Inc.) in a 25° C./30% relative humidity environment at 550 nm, after allowing each film to stand in a 25° C./30% relative humidity environment for 2 hours. The value was calculated by extrapolation of retardation values obtained by perpendicular measurement and retardation values obtained in the same way while inclining the film plane.

Rth(80%) was measured using AxoScan (from Axometrics, Inc.) in a 25° C./80% relative humidity environment at 550 nm, after allowing each individual film to stand in a 25° C./80% relative humidity environment for 2 hours. The value was calculated by extrapolation of retardation values obtained by perpendicular measurement and retardation values obtained in the same way while inclining the film plane.

Using Rth(30%) and Rth(80%), ΔRth(RH)/Rth(550) was determined.

Rth(60° C.90% 1d) was measured using AxoScan (from Axometrics, Inc.) in a 25° C./60% relative humidity environment at 550 nm, after allowing each film, bonded to a glass plate, to stand in a 60° C./90% relative humidity environment for 24 hours, and further in a 25° C./60% relative humidity environment for 6 hours. The value was calculated by extrapolation of retardation values obtained by perpendicular measurement and retardation values obtained in the same way while inclining the film plane.

Rth(initial) was measured using AxoScan (from Axometrics, Inc.) in a 25° C./60% relative humidity environment at 550 nm, after allowing each film, bonded to a glass plate, to stand in a 25° C./60% relative humidity environment for 6 hours. The value was calculated by extrapolation of retardation values obtained by perpendicular measurement and retardation values obtained in the same way while inclining the film plane.

Using Rth(60° C.90% 1d) and Rth(initial), ΔRth(60° C.90% 1d)/Rth(550) was determined. ΔRth(60° C.90% 1d)=Rth(60° C.90% 1d)−Rth(initial) now holds.

For bonding to a glass plate, the optical film was bonded to Eagle XG (Corning) by SK-2057 (Soken Chemical & Engineering Co. Ltd).

### <Dimensional Change Rate in MD Direction and TD Direction>

Prepared were a film sample of 25 cm long (in the direction of measurement) and 5 cm wide, cut out from the film with the longitudinal direction thereof aligned to the MD direction of the film (direction of casting of the web (longitudinal direction)), and, a film sample cut from the film with the longitudinal direction aligned to the direction perpendicular thereto. The samples were pierced to form pinholes at a 20 cm interval, allowed to be conditioned at 25° C., 60% relative humidity for 24 hours, and then measured regarding the distance between the pinholes using a pin gauge (measured value denoted by L₀). Next, the samples were kept under a hot and humid environment at 60° C., 90% relative humidity for 24 hours, further conditioned at 25° C., 60% relative humidity for 2 hours, and the distance between the pinholes was again measured using the pin gauge (measured value denoted by L₁). Using these measured values, the dimensional change rate was calculated according to the equation below.

Dimensional change rate [%]=(L₁−L₀)/L₀}×100

TABLE 2

| | | Formulation | | | | | | | | | | | | | | |
|---|---|---|---|---|---|---|---|---|---|---|---|---|---|---|---|---|
| | | | | | Monocyclic | | | | Film characteristics | | | | | | | |
| | | | Plasticizer | | compound | | | | | | | | | | Dimensional | Dimensional |
| | | | | Amount of | | Amount of | Method of | | | | | | | | change | change |
| | | | | addition | | addition | manufacturing | | | | | | | | rate in | rate in |
| | | Degree of | | (parts | | (parts | Stretching | Factor of TD | | Re | Rth | | ΔRth | ΔRth (60° C. | MD | TD |
| | | substitution by | | by | | by | temperature | stretching | Thickness | (550) | (550) | ΔRe (λ) | (RH)/ | 90%, 1 d)/ | direction | direction |
| | | acyl group | Species | mass) | Species | mass) | (° C.) | (%) | (μm) | (nm) | (nm) | (nm) | Rth (550) | Rth (550) | (%) | (%) |
| Film 1 | Example 1 | 2.4 | A-5 | 13 | 1-a | 2.5 | 165 | 35 | 35 | 43 | 112 | −0.8 | 0.09 | 0.01 | −0.24 | −0.11 |
| Film 2 | Example 2 | 2.4 | A-5 | 13 | 3-a | 2.5 | 165 | 35 | 35 | 42 | 114 | 0.1 | 0.09 | 0.01 | −0.20 | −0.13 |
| Film 3 | Example 3 | 2.4 | A-5 | 13 | 6-a | 2.5 | 165 | 35 | 35 | 47 | 118 | −0.1 | 0.09 | 0.01 | −0.21 | −0.12 |
| Film 4 | Example 4 | 2.4 | A-5 | 13 | 7-a | 2.5 | 165 | 35 | 35 | 41 | 110 | 2.1 | 0.09 | 0.04 | −0.18 | −0.11 |
| Film 5 | Example 5 | 2.4 | A-5 | 13 | 8-a | 2.5 | 165 | 35 | 35 | 45 | 115 | 2.2 | 0.09 | 0.04 | −0.25 | −0.11 |
| Film 6 | Example 6 | 2.4 | A-5 | 13 | 1-b | 2.5 | 165 | 35 | 35 | 39 | 109 | −0.6 | 0.10 | 0.02 | −0.16 | −0.20 |
| Film 7 | Example 7 | 2.4 | A-5 | 13 | 6-b | 2.5 | 165 | 35 | 35 | 42 | 111 | −0.2 | 0.10 | 0.02 | −0.24 | −0.18 |
| Film 8 | Example 8 | 2.4 | A-5 | 13 | 1-d | 2.5 | 165 | 35 | 35 | 49 | 124 | −1.7 | 0.08 | 0.03 | −0.21 | −0.12 |
| Film 9 | Example 9 | 2.4 | A-5 | 9 | 6-a | 2.5 | 165 | 35 | 29 | 45 | 115 | 0.3 | 0.09 | 0.01 | −0.47 | −0.54 |
| Film | Example | 2.1 | A-5 | 13 | 6-a | 2.5 | 165 | 35 | 35 | 45 | 116 | −2.4 | 0.07 | 0.01 | −0.30 | −0.30 |
| 10 | 10 | | | | | | | | | | | | | | | |
| Film | Example | 2.4 | B16 | 7 | 1-a | 2.5 | 165 | 35 | 31 | 43 | 113 | −0.6 | 0.10 | 0.03 | −0.22 | −0.14 |
| 11 | 11 | | | | | | | | | | | | | | | |
| Film | Example | 2.4 | B16 | 7 | 3-a | 2.5 | 165 | 35 | 31 | 47 | 118 | 0 | 0.10 | 0.02 | −0.20 | −0.11 |
| 12 | 12 | | | | | | | | | | | | | | | |
| Film | Example | 2.4 | B16 | 7 | 6-a | 2.5 | 165 | 35 | 31 | 39 | 109 | −0.3 | 0.11 | 0.02 | −0.17 | −0.21 |
| 13 | 13 | | | | | | | | | | | | | | | |
| Film | Example | 2.4 | B16 | 7 | 6-a | 2.5 | 157 | 35 | 28 | 43 | 116 | −0.4 | 0.09 | 0.01 | −0.52 | −0.62 |
| 14 | 14 | | | | | | | | | | | | | | | |
| Film | Example | 2.4 | A-5 | 13 | 6-a | 5 | 165 | 35 | 29 | 46 | 112 | −1.5 | 0.07 | 0.04 | −0.32 | −0.30 |
| 15 | 15 | | | | | | | | | | | | | | | |
| Film | Comparative | 2.7 | A-5 | 13 | 6-a | 2.5 | 165 | 35 | 61 | 47 | 118 | 2.1 | 0.09 | 0.01 | −0.21 | −0.12 |
| 16 | Example 1 | | | | | | | | | | | | | | | |
| Film | Comparative | 1.7 | A-5 | 13 | 6-a | 2.5 | 165 | 35 | Not evaluable due to whitening. | | | | | | | |
| 17 | Example 2 | | | | | | | | | | | | | | | |
| Film | Comparative | 2.4 | A-5 | 13 | N1 | 2.5 | 165 | 35 | 28 | 45 | 123 | −1.1 | 0.14 | 0.08 | −0.28 | −0.21 |
| 18 | Example 3 | | | | | | | | | | | | | | | |
| Film | Comparative | 2.4 | A-5 | 13 | — | — | 185 | 35 | 38 | 45 | 115 | 4.7 | 0.18 | 0.01 | −0.31 | −0.40 |
| 19 | Example 4 | | | | | | | | | | | | | | | |
| Film | Comparative | 2.1 | A-5 | 13 | — | — | 185 | 35 | 32 | 43 | 112 | 4.5 | 0.18 | 0.01 | −0.28 | −0.43 |
| 20 | Example 5 | | | | | | | | | | | | | | | |
| Film | Comparative | 2.5 | A-7/ | 8/15 | — | — | 150 | 35 | 45 | 43 | 112 | 2.1 | 0.12 | 0.01 | 0.20 | 0.05 |
| 21 | Example 6 | | B-15 | | | | | | | | | | | | | |
| Film | Example | 2.5 | A-7 | 10 | 5-b | 3 | 150 | 35 | 38 | 45 | 115 | −1 | 0.10 | 0.01 | 0.20 | 0.05 |
| 22 | 16 | | | | | | | | | | | | | | | |
| Film | Example | 2.4 | A-5 | 13 | 6-a | 2.5 | 170 | 40 | 35 | 47 | 118 | −0.1 | 0.09 | 0.01 | −0.28 | −0.17 |
| 23 | 17 | | | | | | | | | | | | | | | |
| Film | Comparative | 2.5 | A-7/ | 8/15 | — | — | 160 | 40 | 45 | 43 | 113 | 2.1 | 0.12 | 0.01 | 0.10 | −0.05 |
| 24 | Example 7 | | B-15 | | | | | | | | | | | | | |
| Film | Example | 2.5 | A-7 | 10 | 5-b | 3 | 160 | 40 | 38 | 45 | 113 | −1 | 0.1 | 0.01 | 0.08 | −0.07 |
| 25 | 18 | | | | | | | | | | | | | | | |

### (Manufacture of Polarizing Plate)

### <Manufacture of Film O1>

In the description below regarding manufacture based on co-casting, a layer derived from the main stream is referred to as a core layer, a layer on the support side as a support-faced layer, and a layer opposite to the support layer as an air-faced layer.

—Preparation of Core Layer forming Dope 1—

A core layer forming dope 1 having the composition below was prepared.

Composition of Dope 1

| | |
|---|---|
| Cellulose acetate (degree of acetyl substitution = 2.86; | 100 parts by mass |
| number-average molecular weight = 72000) | |
| Methylene chloride (first solvent) | 320 parts by mass |
| Methanol (second solvent) | 83 parts by mass |
| 1-Butanol (third solvent) | 3 parts by mass |
| Additive T | 10 parts by mass |
| Additive UV1 | 1 part by mass |

Additive T: Ratio of mixing = 1:1 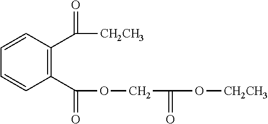 [SMILES: CCOC(=O)COC(=O)c1ccccc1C(=O)CC] 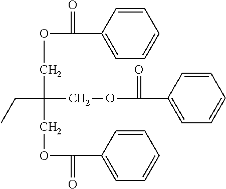 [SMILES: CCC(COC(=O)c1ccccc1)(COC(=O)c1ccccc1)COC(=O)c1ccccc1]
Additive UV1:

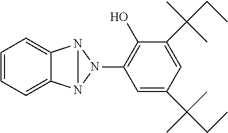 [SMILES: CCC(C)(C)c1cc(-n2n3c4ccccc4n23)c(O)c(C(C)(C)CC)c1]

Specifically, the core forming dope 1 was prepared according to the method described below.

To a 400-L stainless steel dissolution tank equipped with a stirring blade, while thoroughly stirring and dispersing therein the above-described mixed solvent, cellulose acetate powder (flake), and additives T and UV 1 were gradually added, so as to adjust the total weight to 2000 kg. Every solvent used here had a moisture content of 0.5% by mass or below. The cellulose acetate powder, after placed in the dispersion tank, was initially dispersed based on shearing under stirring for 30 minutes, using a dissolver-type decentered stirrer shaft driven at a peripheral speed of 5 m/sec (shear stress=5×10⁴ kgf/m/sec²), and an anchor blade disposed as the center shaft driven at a peripheral speed of 1 m/sec (shear stress=1×10⁴ kgf/m/sec²). The start temperature of dispersion was 25° C., and the final temperature reached 48° C. After completion of dispersion, high-speed stirring was terminated, the peripheral speed of the anchor blade was slowed down to 0.5 msec for further stirring for 100 minutes, to thereby allow the cellulose acetate to swell.

The swelled liquid in the tank was heated through a jacketed piping to 50° C., and further to 90° C. for complete dissolution. The heating time was 15 minutes.

Next, the liquid was cooled down to 36° C., and filtered through a filter material with a nominal pore size of 8 μm, to obtain a dope.

The thus obtained pre-condensed dope was allowed to flash at 80° C. in the tank at normal pressure, and the vaporized solvent was collected and isolated using a condenser. The solid content of the dope after flashed was found to be 21.8% by mass. The flash tank used here was equipped with an anchor blade as the center shaft, which was driven at a peripheral speed of 0.5 m/sec for defoaming. Temperature of the dope in the tank was 25° C., and an average residence time in the tank was 50 minutes.

The dope was then initially allowed to pass through a sintered metal fiber filter with a nominal pore size of 10 μm, while pressurized at 1.5 MPa, and then allowed to pass through a sintered fiber filter again with a nominal pore size of 10 μm. The filtered dope was kept at 36° C., and stored in a 2000-L stainless steel stock tank. The stock tank used here was equipped with an anchor blade as the center shaft, and constantly driven at a peripheral speed of 0.3 m/sec for stirring, thereby the core layer forming dope 1 was obtained.

### —Preparation of Support-Faced Layer Forming Dope 2—

A matting agent (silicon dioxide (particle size=20 nm)) and the core layer forming dope 1 were mixed using a static mixer to thereby prepare a support-faced layer forming dope 2. The contents were adjusted to 20.2% by mass for the total solid content, and to 0.033% by mass for the matting agent.

—Preparation of Air-Faced Layer forming Dope 3—

A matting agent (silicon dioxide (particle size=20 nm)) was mixed to the core layer forming dope 1 using a static mixer to thereby prepare an air-faced layer forming dope 3. The contents were adjusted to 20.2% for the total solid content, and to 0.033% by mass for the matting agent.

### —Manufacture by Co-Casting—

An apparatus used here was equipped, as a casting die, with a feed block which was configured to enable co-casting, in such a way that a main stream can be laminated respectively on both sides thereof to produce a three-layered film. The dopes were fed through three flow channels assigned to those for forming core layer, support-faced layer, and air-faced layer.

The core layer forming dope 1, the support-faced layer forming dope 2, and the air-faced layer forming dope 3 were co-cast through an outlet onto a drum cooled at −5° C. In this process, flow rates of the individual dopes were controlled so as to give a final ratio of thickness of air-faced layer/core layer/support-faced layer=3 μm/54 μm/3 μm. The cast dope film was blown with a dry air of 34° C. at 230 m³/min on the drum, and then peeled off from the drum. In the process of peeling, the film was concurrently stretched by 17% in the feeding direction (longitudinal direction). The film was then conveyed while being held on both sides thereof in the widthwise direction of the film (direction perpendicular to the casting direction) using a pin tenter (pin tenter illustrated in FIG. 3 of JP-A-H04-1009). The film was further dried by conveying it through among rolls of an annealing apparatus, to thereby manufacture a film O1 of 60 μm thick (also referred to as outer film O1).

Moisture permeability of the film O1, after allowed to stand at 40° C., 90% for 24 hours, was measured according to the method described below, and was found to be 580 g/m².

### <<Measurement of Moisture Permeability>>

Moisture permeability of the film was measured according to a method specified by JIS Z0208 “Testing Methods for Determination of the Water Vapour Transmission Rate of Moisture-Proof Packaging Materials (Dish Method)” (40° C., 90% relative humidity).

<Manufacture of Film O2 Showing Moisture Permeability of 100 g/m² or Below, after Allowed to Stand at 40° C., 90% for 24 Hours>

Pellets, composed of a mixture (Tg=127° C.) of 90 parts by mass of (meth)acrylate-base resin having a lactone ring structure represented by the Formula (10) below {ratio by mass of co-polymerized monomers=methyl methacrylate/2-(hydroxymethyl)methyl acrylate=8/2, ratio of lactone cyclization 100%, ratio of content of lactone ring structure=19.4%, mass-average molecular weight=133000, melt flow rate=6.5 g/10 min (240° C., 10 kgf (98.1 N)), glass transition temperature (Tg)=131° C.}, and 10 parts by mass of acrylonitrile-styrene (AS) resin {Toyo AS AS20, from Toyo Styrene Co., Ltd.}, were fed to a double screw extruder, and melt-extruded at approximately 280° C. into a sheet, to thereby obtain a (meth)acrylate-base resin sheet of 80 μm thick, having the lactone ring structure. The unstretched sheet was then stretched at 160° C., 1.5-fold longitudinally and 1.8-fold transversely, to obtain a (meth)acrylate-base resin film O2 (thickness=40 μm, in-plane retardation Re=0.8 nm, thicknesswise retardation Rth=1.5 nm) (also referred to as “outer film O2”). The thus manufactured (meth)acrylate-base resin film O2 showed a dimensional change rate induced by moisture in the machine direction (MD) of 0.35%.

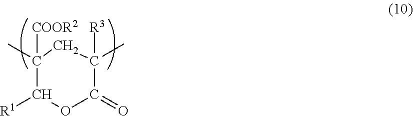

R¹ represents a hydrogen atom, and each of R² and R³ represents a methyl group.

Moisture permeability of the film O2 after allowed to stand at 40° C., 90% for 24 hours, was measured in the same way as that of the film O1, and was found to be 75 g/m².

### <Manufacture of Film O3 >

Cosmoshine SRF (80 μm thick, from Toyobo Co., Ltd.) was used as a film O3 (also referred to as “outer film O3”). Moisture permeability of the film O3 after allowed to stand at 40° C., 90% for 24 hours, was measured in the same way as that of the film O1, and was found to be 20 g/m².

### (Wavy Curl of Polarizing Plate)

A rolled polyvinyl alcohol film was continuously stretched five-fold in an aqueous iodine solution, and then dried to obtain a polarizer. Each of the optical film of Example 3 and an outer film O1 were alkali-saponified by immersing the films in 2 mol % sodium hydroxide solution at 50° C. for 90 seconds, followed by washing with water and drying. The thus obtained alkali-saponified optical film of Example 3 and a protective film were bonded while placing the polarizer in between and while directing the saponified surface to the polarizer, using a 3% aqueous polyvinyl alcohol (PVA-117H, from Kuraray Co., Ltd.) solution as an adhesive, to thereby obtain a polarizing plate configured by the optical film of Example 3, the polarizer, and the outer film O1 bonded in this order. In this process, the optical film of this invention and the protective film (outer film) were bonded so as to align the MD direction (film feeding direction) of them in parallel to the absorption axis of the polarizer. Further, an acrylic adherent layer of 15 μm thickness was provided on a surface of the retardation film of the polarizing plate, and a separate film of 38 μm thickness was bonded to its outer side. An acrylic adherent layer and a protective film of 60 μm thickness which is composed of polyethylene terephthalate were bonded to the surface of the polarizing plate at the side of the outer film (TD60US) to prepare polarizing plate 101 for evaluation. Polarizing plates 102-110 were prepared in the same way as in polarizing plate 101 except that the thickness of polarizer and the type of the optical film were changed as shown in Table below.

### (Method for Evaluation of Wavy Curl)

The aforementioned obtained polarizing plates were punched into rectangle having a long side of 1150 mm and a short side of 645 mm in a state that the absorption axis of the polarizing plate was parallel to the short side. The punched polarizing plate was left stand on a flat under a condition of 23° C. and 55% RH for 24 hours in a state where the separate film was located beneath. Then, the site which floated from the flat on the four sides of the polarizing plate was identified as a wave. For each wave, the maximum height of the float from the flat was measured as a wave height by using a straight measure silver (Shinwa Rules Co., Ltd.). The height of each wave of each side of the polarizing plate was measured while the polarized film was left stand in a state where the separate film was located beneath or in a state where the separate film was located above.

The site with a wave height of 1 mm or more was counted as one wave. The number of the wave and the height of the wave were measured for each side of the polarizing plate. The measurement results are shown in table below. The maximum value among the number of the wave of each side is referred to as “wave number” and the maximum height of the wave among all measurement results is referred to as “wave height”. A sample having a wave height of 3 mm or less and a wave number of 3 or less can be practically used without a problem.

The polarizing plate with a biaxially stretched optical film (optical films 23, 24 and 25) showed more excellent wave height and more excellent wave number as compared with an uniaxially stretched optical film (optical films 3, 21 and 22). The polarizing plate with a polarizer having a thickness of 10 μm showed more excellent wave height and wave number, as compared with the polarizing plate with a polarizer having a thickness of 25 μm.

TABLE 3

| | Optical | | | Wavy curl | |
|---|---|---|---|---|---|
| Polarizing | Film | Thickness of | Opposed | Wave | Wave |
| Plate No. | No. | polarizer (μm) | film | height (mm) | number |
| Polarizing | Film 3 | 25 | O1 | 3 | 3 |
| Plate 101 | | | | | |
| Polarizing | Film 21 | 25 | O1 | 3 | 3 |
| Plate 102 | | | | | |
| Polarizing | Film 22 | 25 | O1 | 3 | 3 |
| Plate 103 | | | | | |
| Polarizing | Film 23 | 25 | O1 | 2 | 2 |
| Plate 104 | | | | | |
| Polarizing | Film 24 | 25 | O1 | 2 | 2 |
| Plate 105 | | | | | |
| Polarizing | Film 25 | 25 | O1 | 2 | 2 |
| Plate 106 | | | | | |
| Polarizing | Film 21 | 10 | O1 | 1 | 2 |
| Plate 107 | | | | | |
| Polarizing | Film 22 | 10 | O1 | 1 | 2 |
| Plate 108 | | | | | |
| Polarizing | Film 24 | 10 | O1 | 0.5 | 0 |
| Plate 109 | | | | | |
| Polarizing | Film 25 | 10 | O1 | 0.5 | 0 |
| Plate 110 | | | | | |

### (Evaluation of Liquid Crystal Display Device)

### <Manufacture of Polarizer>

A polyvinyl alcohol film of 75 μm thick, having a refractive index at 380 nm of 1.545, and a refractive index at 780 nm of 1.521, was unidirectionally stretched 2.5-fold, dipped in an aqueous solution at 30° C. containing 0.2 g/L of iodine and 60 g/L of potassium iodide for 240 seconds, and then dipped in an aqueous solution containing 70 g/L of boric acid and 30 g/L of potassium iodide and, at the same time, uniaxially stretched 6.0-fold and kept for 5 minutes. Lastly the film was dried at room temperature for 24 hours, to thereby obtain a polarizer P having an average thickness of 25 μm and a degree of polarization of 99.998%.

### <Manufacture of Polarizing Plate 1 by Wet Lamination>

Using the film 1, the outer film O1 and the polarizer P manufactured above, a polarizing plate 1 was manufactured according to the steps 1 to 5 below.

Step 1: The film 1 and the outer film O1 were immersed into a 2 mol % sodium hydroxide solution at 50° C. for 90 seconds, rinsed with water and dried, to thereby saponify the surfaces thereof to be laminated with the polarizer.

Step 2: The polarizer P was immersed into a polyvinyl alcohol adhesive bath with a solid content of 2% by mass for 1 to 2 seconds.

Step 3: The polarizer P was lightly wiped to remove an excessive adhesive adhered thereon in step 2, and then arranged in a stacked manner with the film 1 and the outer film O1 treated in step 1.

Step 4: The stack obtained in step 3 was laminated under a pressure of 20 to 30 N/cm² applied from the opposite side of the film 1 (side of the outer film O1) at a feed speed of approximately 2 m/min.

Step 5: A sample, manufactured in step 4 by laminating the polarizer, the film 1 and the outer film O1, was dried in a drying oven at 80° C. for 5 minutes, to thereby manufacture a polarizing plate 1.

### <Manufacture of Polarizing Plates 2, 12 to 17, 20, 23 to 28, 30 to 32 by Wet Lamination>

Polarizing plates were manufactured in the same way as the polarizing plate 1, except that the film 1 and the outer film O1 were replaced with those summarized in Table below.

### <Manufacture of Polarizing Plate 3 by Dry Lamination>

### (Preparation of Active Energy Ray Curable Adhesive)

Thirty-five parts by mass of high-purity hydrogenated epoxy agent (“jER YX8000”, from Mitsubishi Chemical Corporation), 4 parts by mass of triarylsulfonyl salt compound (“CPI-100P”, from San-Apro Ltd.), and 1 part by mass of benzoin methyl ether (from Tokyo Chemical Industry Co., Ltd.) were mixed, to obtain an active energy ray curable adhesive.

The polarizer P was held between the film 1 and the outer film O2, while respectively placing the active energy ray curable adhesive in between, laminated to each other, and irradiated with ultraviolet radiation with a cumulative radiation of 3000 mJ/cm², to thereby obtain a polarizing plate 3.

### <Manufacture of Polarizing Plates 4 to 11, 18, 19, 21, 22, 29 by Dry Lamination>

Polarizing plates were manufactured in the same way as the polarizing plate 3, except that the film 1 and the outer film O2 were replaced with those summarized in Table below.

### (Evaluation)

The thus obtained polarizing plates 1 to 32 were evaluated as follows.

### <Widthwise Variation in Axes of Polarizing Plate (Axial Deviation)>

The thus obtained polarizing plate was unwound 10 meters, every five pieces was sampled at 2-meter intervals in the longitudinal direction, and at regular intervals in the widthwise direction, and angle between the slow axis of each optical film and the absorption axis of the polarizer was measured using AxoScan (from Axometrics, Inc.). Axial deviation was calculated using the equation below, and the result was judged as follows. Ratings of 0 and 1 represent practically acceptable levels.

(Axial Deviation)=|(Angle formed in between)−90°|

0: 0°≦(maximum axial deviation)≦0.15°
1: 0.15°<(maximum axial deviation)≦0.3°
2: 0.3°<(maximum axial deviation)≦0.5°
3: 0.5°<(maximum axial deviation)

### (Manufacture of Liquid Crystal Display Device)

Each of the thus obtained polarizing plates of Examples and Comparative Examples were laminated to the panel described below.

From a liquid crystal display device LC-46LV3, a product of SHARP Corporation, the polarizing plates on the front side and the rear side were removed (the resultant is referred to as “panel”, hereinafter), and the polarizing plates of Example 101 were arranged on the front side and the rear side of the liquid crystal panel, to thereby manufacture a liquid crystal display device of Example 101. The polarizing plate of Example 101 was now disposed so that the optical film of this invention (film 1) was positioned closer to the liquid crystal cell. Also the polarizing plates of other Examples and Comparative Examples were arranged on the front side and the rear side of the liquid crystal panel in the same way as described above, to thereby manufacture liquid crystal display devices of the other Examples and Comparative Examples.

### <Hue Change in Oblique View>

Each of the thus manufactured liquid crystal display devices was measured regarding hue change Δu′v′ in the black display, according the equation below. Now, u′max (v′max) represents a maximum u′(v′) measured at a polar angle of 60° and an azimuth ranged from 0 to 360°, and u′min (v′min) represents a minimum u′(v′) measured at a polar angle of 60° and an azimuth ranged from 0 to 360°. Results are summarized in Table below.

Δu′v′=\sqrt{(u′max−u′min)²+(v′max−v′min)²}

0: ≦0.02
1: >0.02, ≦0.08
2: >0.08
<Non-Uniform Visibility Immediately after Allowed to Stand in 60° C./90% Relative Humidity Environment for 24 Hours>

Each of the thus manufactured liquid crystal display devices was allowed to stand in a 60° C./90% relative humidity environment for 24 hours, and then taken out. The liquid crystal display device was then observed from the front in a darkroom environment, and evaluated according to the criteria below. Ratings of A and B represent practically acceptable levels.

A: Visibility failure not observed (not larger than 5% of screen area).
B: Visibility failure slightly observed (exceeding 5%, and not larger than 15% of screen area).
C: Visibility failure observed (exceeding 15% of screen area).
<Non-Uniform Visibility after Allowed to Stand in 60° C./90% Relative Humidity Environment and then Illuminated for 24 Consecutive Hours in 25° C./60% Relative Humidity Environment>

Each liquid crystal display device was allowed to stand in an 60° C./90% relative humidity environment for 24 hours in the same way as described above, and was successively illuminated in a 25° C./60% environment for 24 consecutive hours. The liquid crystal display device was then observed from the front in a darkroom environment, and evaluated according to the criteria below. Ratings of A, B and C represent practically acceptable levels.

A: Visibility failure not observed (not larger than 5% of screen area).
B: Visibility failure slightly observed (exceeding 5%, and not larger than 10% of screen area).
C: Visibility failure observed a little (exceeding 10%, and not larger than 15% of screen area).
D: Visibility failure observed (exceeding 15% of screen area).

### <Non-Uniform Dewing>

On the surface of the polarizing plate on the viewer's side of the thus manufactured liquid crystal display device, 500 μL of pure water was dropped, and Saran Wrap (registered trademark) (from Asahi Kasei Home Products Corporation) cut into 10 cm×10 cm was placed thereon, and the four sides were sealed with a tape. The liquid crystal display device was illuminated for 24 consecutive hours, Saran Wrap (registered trademark) was removed, and the water droplet on the surface was wiped off. The liquid crystal display device was further illuminated for 24 consecutive hours, and Non-uniformity in the black display was evaluated from the front. Ratings of 0 to 2 represent practically acceptable levels.

3: Strongly observed.
2: Weakly observed.
1: Almost not observed.
0: Not observed.

TABLE 4

| | | | | | | | | Display characteristics | | |
|---|---|---|---|---|---|---|---|---|---|---|
| | | | | | | | | | Non-uniform | |
| | | | | | | | | Non-uniform | visibility after | |
| | | | | | | Axial | | visibility | allowed to stand at | |
| | | | | | | deviation | | immediately | 60° C., 90% relative | |
| | | | | | | in | | after allowed to | humidity for 24 | |
| | | | | | Moisture | widthwise | | stand at | hours and | |
| | | | | | permeability | direction | | 60° C., 90% | illuminated for 24 | |
| | | | | | of outer | of | | relative | consecutive hours in | |
| | | Optical | Outer | Method of | film | polarizing | Hue change in | humidity for 24 | 25° C./60% relative | Non-uniform |
| | | film | film | lamination | (g/m²) | plate | oblique view | hours | humidity | dewing |
| Polarizing | Example 101 | Film 1 | O1 | Wet | 580 | 1 | 0 | A | A | 2 |
| plate 1 | | | | | | | | | | |
| Polarizing | Example 102 | Film 3 | O1 | Wet | 580 | 1 | 0 | A | A | 2 |
| plate 2 | | | | | | | | | | |
| Polarizing | Example 103 | Film 1 | O2 | Dry | 75 | 0 | 0 | A | A | 1 |
| plate 3 | | | | | | | | | | |
| Polarizing | Example 104 | Film 2 | O2 | Dry | 75 | 0 | 0 | A | A | 1 |
| plate 4 | | | | | | | | | | |
| Polarizing | Example 105 | Film 3 | O2 | Dry | 75 | 0 | 0 | A | A | 1 |
| plate 5 | | | | | | | | | | |
| Polarizing | Example 106 | Film 9 | O2 | Dry | 75 | 0 | 0 | A | C | 1 |
| plate 6 | | | | | | | | | | |
| Polarizing | Example 107 | Film | O2 | Dry | 75 | 1 | 2 | A | A | 1 |
| plate 7 | | 10 | | | | | | | | |
| Polarizing | Example 108 | Film | O2 | Dry | 75 | 0 | 0 | B | B | 1 |
| plate 8 | | 11 | | | | | | | | |
| Polarizing | Example 109 | Film | O2 | Dry | 75 | 0 | 0 | B | B | 1 |
| plate 9 | | 13 | | | | | | | | |
| Polarizing | Example 110 | Film | O2 | Dry | 75 | 0 | 0 | A | C | 1 |
| plate 10 | | 14 | | | | | | | | |
| Polarizing | Example 111 | Film | O2 | Dry | 75 | 0 | 1 | B | B | 1 |
| plate 11 | | 15 | | | | | | | | |
| Polarizing | Example 112 | Film 1 | O3 | Wet | 20 | 1 | 0 | A | A | 0 |
| plate 12 | | | | | | | | | | |
| Polarizing | Example 113 | Film 2 | O3 | Wet | 20 | 1 | 0 | A | A | 0 |
| plate 13 | | | | | | | | | | |
| Polarizing | Example 114 | Film 3 | O3 | Wet | 20 | 1 | 0 | A | A | 0 |
| plate 14 | | | | | | | | | | |
| Polarizing | Example 115 | Film | O3 | Wet | 20 | 2 | 2 | A | A | 1 |
| plate 15 | | 10 | | | | | | | | |
| Polarizing | Example 116 | Film | O3 | Wet | 20 | 1 | 0 | A | A | 0 |
| plate 16 | | 11 | | | | | | | | |
| Polarizing | Example 117 | Film | O3 | Wet | 20 | 1 | 0 | B | B | 0 |
| plate 17 | | 15 | | | | | | | | |
| Polarizing | Example 118 | Film 1 | O3 | Dry | 20 | 0 | 0 | A | A | 0 |
| plate 18 | | | | | | | | | | |
| Polarizing | Example 119 | Film 3 | O3 | Dry | 20 | 0 | 0 | A | A | 0 |
| plate 19 | | | | | | | | | | |
| Polarizing | Example 120 | Film 4 | O1 | Wet | 580 | 1 | 0 | B | B | 2 |
| plate 20 | | | | | | | | | | |
| Polarizing | Example 121 | Film 5 | O2 | Dry | 75 | 0 | 0 | B | B | 1 |
| plate 21 | | | | | | | | | | |
| Polarizing | Comparative | Film | O2 | Dry | 75 | 0 | 0 | C | D | 1 |
| plate 22 | example 101 | 16 | | | | | | | | |
| Polarizing | Comparative | Film | O1 | Wet | 580 | 1 | 0 | C | D | 2 |
| plate 23 | example 102 | 16 | | | | | | | | |
| Polarizing | Comparative | Film | O1 | Wet | 580 | 2 | 0 | C | D | 2 |
| plate 24 | example 103 | 18 | | | | | | | | |
| Polarizing | Comparative | Film | O1 | Wet | 580 | 3 | 0 | C | D | 2 |
| plate 25 | example 104 | 19 | | | | | | | | |
| Polarizing | Comparative | Film | O1 | Wet | 580 | 3 | 0 | C | D | 3 |
| plate 26 | example 105 | 20 | | | | | | | | |
| Polarizing | Comparative | Film | O1 | Wet | 580 | 1 | 0 | C | D | 2 |
| plate 27 | example 106 | 21 | | | | | | | | |
| Polarizing | Example 122 | Film | O1 | Wet | 580 | 1 | 1 | A | A | 2 |
| plate 28 | | 22 | | | | | | | | |
| Polarizing | Example 123 | Film | O2 | Dry | 75 | 0 | 1 | A | A | 1 |
| plate 29 | | 22 | | | | | | | | |
| Polarizing | Example 124 | Film | O1 | Wet | 580 | 1 | 0 | A | A | 2 |
| plate 30 | | 23 | | | | | | | | |
| Polarizing | Comparative | Film | O1 | Wet | 580 | 1 | 0 | C | D | 2 |
| plate 31 | example 107 | 24 | | | | | | | | |
| Polarizing | Example 125 | Film | O1 | Wet | 580 | 1 | 1 | A | A | 2 |
| plate 32 | | 25 | | | | | | | | |

It was understood from Table above that the polarizing plate and the liquid crystal display device using the optical film of the present invention showed less non-uniform visibility immediately after allowed to stand in a 60° C./90% relative humidity environment for 24 hours, and less non-uniform visibility after allowed to stand in 60° C./90% relative humidity environment for 24 hours and then illuminated for 24 consecutive hours in 25° C./60% relative humidity environment, and were therefore found to be good in moisture dependence, and optical stability under hygrothermal conditions. It was also understood that they showed small Au′v′, which represents hue change in oblique view, so that the positive wavelength dispersion of optical characteristics is not so strong but retained at appropriate levels.

In contrast, Comparative Examples using the optical films which do not satisfy at least either of Formula 1 or Formula 2, were found to fail in balancing thinness with moisture dependence and optical stability under hygrothermal conditions.

Example using the film 10 which falls below the lower limit specified by Formula 3, was found to show somewhat poor hue change as compared with other Examples.

1. An optical film comprising a cellulose acylate whose degree of substitution of acyl group is from 2.0 to 2.6, satisfying Formula 1 and Formula 2 below, and having a thickness of 40 μm or thinner;
ΔRth(RH)/Rth(550)<0.12 Formula 1:
ΔRth(60° C.90% 1d)/Rth(550)<0.05 Formula 2:
in the formulae,
ΔRth(RH)=Rth(30%)−Rth(80%),
wherein Rth(30%) representing thicknesswise retardation Rth of the optical film measured at a wavelength of 550 nm in a 25° C./30% relative humidity environment, after the optical film allowed to stand in a 25° C./30% relative humidity environment for 2 hours, and
Rth(80%) representing thicknesswise retardation Rth of the optical film measured at a wavelength of 550 nm in a 25° C./80% relative humidity environment, after the optical film allowed to stand in a 25° C./80% relative humidity environment for 2 hours; and
ΔRth(60° C.90% 1d)=Rth(60° C.90% 1d)−Rth(initial),
wherein Rth(initial) representing thicknesswise retardation Rth of the optical film, as bonded to a glass plate, measured at a wavelength of 550 nm after the optical film allowed to stand in a 25° C./60% relative humidity environment for 6 hours, and
Rth(60° C.90% 1d) representing thicknesswise retardation Rth of the optical film, as bonded to a glass plate, measured at a wavelength of 550 nm after the optical film allowed to stand in a 60° C., 90% relative humidity environment for 24 hours, and further in a 25° C./60% relative humidity environment for 6 hours, and
Rth(550) representing thicknesswise retardation of the optical film measured at a wavelength of 550 nm.

2. The optical film of claim 1, having a dimensional change rate of −0.5 to +0.5% between before and after the optical film allowed to stand in a 60° C./90% relative humidity environment for 24 hours, measured in the direction parallel to slow axis or in the direction perpendicular to the slow axis.

3. The optical film of claim 1, further satisfying Formula 3 below:
−2 nm≦ΔRe(λ)≦2 nm Formula 3:
wherein ΔRe(λ)=Re(630)−Re(450), Re(630) representing in-plane retardation at a wavelength of 630 nm, and Re(450) representing in-plane retardation at a wavelength of 450 nm.

4. The optical film of claim 2, further satisfying Formula 3 below:
−2 nm≦ΔRe(λ)≦2 nm Formula 3:
wherein ΔRe(λ)=Re(630)−Re(450), Re(630) representing in-plane retardation at a wavelength of 630 nm, and Re(450) representing in-plane retardation at a wavelength of 450 nm.

5. A polarizing plate having at least the optical film of claim 1 and a polarizer.

6. A polarizing plate having at least the optical film of claim 2 and a polarizer.

7. A polarizing plate having at least the optical film of claim 3 and a polarizer.

8. A polarizing plate having at least the optical film of claim 4 and a polarizer.

9. A polarizing plate comprising the optical film of claim 1, a film having a moisture permeability of 100 g/m² or less after allowed to stand in a 40° C./90% relative humidity environment for 24 hours, and a polarizer held in between.

10. A polarizing plate which comprising the optical film of claim 2, a film having a moisture permeability of 100 g/m² or less after allowed to stand in a 40° C./90% relative humidity environment for 24 hours, and a polarizer held in between.

11. A polarizing plate comprising the optical film of claim 3, a film having a moisture permeability of 100 g/m² or less after allowed to stand in a 40° C./90% relative humidity environment for 24 hours, and a polarizer held in between.

12. A polarizing plate comprising the optical film of claim 4, a film having a moisture permeability of 100 g/m² or less after allowed to stand in a 40° C./90% relative humidity environment for 24 hours, and a polarizer held in between.

13. The polarizing plate of claim 9, wherein the film having a moisture permeability of 100 g/m² or less after allowed to stand in a 40° C./90% relative humidity environment for 24 hours, and the polarizer are bonded using an active energy curable adhesive.

14. A liquid crystal display device comprising the optical film of claim 1

15. A liquid crystal display device comprising the optical film of claim 2.

16. A liquid crystal display device comprising the optical film of claim 3.

17. A liquid crystal display device comprising the optical film of claim 4.

18. A liquid crystal display device comprising the polarizing plate of claim 5.

19. A liquid crystal display device comprising the polarizing plate of claim 9.

20. A liquid crystal display device comprising the polarizing plate of claim 13.
